(19) United States
(12) Patent Application Publication
(10) Pub. No.: US 2013/0015675 A1
(43) Pub. Date: Jan. 17, 2013

(54) APPARATUS, SYSTEM, AND METHOD FOR LAYER PICKING AND ORDER FULFILLMENT FOR ITEMS STORED IN A WAREHOUSE

(71) Applicants: DOUGLAS PICKARD, St. Catharines (CA); Luis Graca, North York (CA)

(72) Inventors: DOUGLAS PICKARD, St. Catharines (CA); Luis Graca, North York (CA)

(21) Appl. No.: 13/184,352

(22) Filed: Jul. 15, 2011

(51) Int. Cl. B65G 59/04; B66C 1/00; B65G 57/24; B66C 17/00; B66C 19/00; B66C 1/02; B66C 1/44

(52) U.S. Cl. 294/24; 212/71; 414/796.2; 212/327; 414/791.6; 414/802

(57) ABSTRACT

An apparatus for picking and placing a layer of product, comprising: a frame, the frame movable from a first position above and clear of the layer of product to a second position over and enclosing the layer of product; paddles mounted on internal sides of the frame, each paddle moveable from a first position in which the paddle is clear of the layer of product to a second position in which the paddle engages and grips a respective side of the layer of product by applying mechanical force thereto; a vacuum duct mounted in the frame over the layer of product, the vacuum duct moveable from a first position in which the vacuum duct is clear of the layer of product to a second position in which the vacuum duct engages and grips a top of the layer of product by applying vacuum force thereto; and, a control system adapted to selectively control respective mechanisms for positioning of the frame, paddles, and vacuum duct to thereby pick and place the layer of product.

### FIELD OF THE INVENTION

This invention relates to the field of warehouse management systems, and more specifically, to an apparatus, system, and method for layer picking and order fulfillment for items stored in a warehouse.

### BACKGROUND OF THE INVENTION

A warehouse management system (“WMS”) assists in the management of movement and storage of materials within a warehouse. It automates and centralizes the management of inventory levels, stock locations, material receiving, packing and shipping. A WMS is a key part of the supply chain and primarily aims to control the movement and storage of materials within a warehouse and process the associated transactions, including shipping, receiving, putaway and picking. In modern warehouses, stock items are typically stored in layered stacks on pallets.

One aspect of warehouse management relates to layer picking and order fulfillment for stock items that are stored in layered stacks on pallets. While most order picking systems still perform this task by hand, some automated systems have been proposed. However, these existing systems have several disadvantages. For example, some layer picking systems use a mechanical (normally hydraulic) gripper on a forklift and the operator positions the tool over the pallet and then activates the gripper. While such systems may be suitable for some sturdy products, they often take up significant warehouse space and have limited picking rates. Other layer picking systems automatically move the source pallet underneath a picking head and a picking head picks a layer and transfers it to an order pallet. By cycling the needed source pallets through the source area, orders may be created. Sometimes order pallets are cycled through as well to achieve higher throughput. The disadvantage of these systems is that they require significant pallet handling and manipulation. Still other layer picking systems handle single layers only with vacuum or mechanical gripping depending on the product. These systems are often limited with respect to the type of product that can be handled and they typically require means for initially placing source pallets. Finally, some layer picking systems use a vacuum system and a pressurized skirt to enhance the vacuum by forming an improved seal around the product. These systems provide for product handling flexibility but are often slow and require the delivery of source pallets. These and other known systems are described in patents and published patent applications such as U.S. Pat. No. 6,589,001 to Peltomaki, U.S. Pat. No. 7,481,472 to Cawley, et al., U.S. Pat. No. 6,802,688 to Andersen, et al., and International Patent Application Publication No. WO 2010/097088 by Christensen, et al., all of which are incorporated herein by reference.

A need therefore exists for an improved apparatus, system, and method for layer picking and order fulfillment for items stored in a warehouse. Accordingly, a solution that addresses, at least in part, the above and other shortcomings is desired.

### SUMMARY OF THE INVENTION

According to one aspect of the invention, there is provided an apparatus for picking and placing a layer of product, comprising: a frame, the frame movable from a first position above and clear of the layer of product to a second position over and enclosing the layer of product; paddles mounted on internal sides of the frame, each paddle moveable from a first position in which the paddle is clear of the layer of product to a second position in which the paddle engages and grips a respective side of the layer of product by applying mechanical force thereto; a vacuum duct mounted in the frame over the layer of product, the vacuum duct moveable from a first position in which the vacuum duct is clear of the layer of product to a second position in which the vacuum duct engages and grips a top of the layer of product by applying vacuum force thereto; and, a control system adapted to selectively control respective mechanisms for positioning of the frame, paddles, and vacuum duct to thereby pick and place the layer of product.

According to another aspect of the invention, there is provided an apparatus for picking and placing a layer of product, a pallet, or the layer of product on the pallet, comprising: a frame, the frame movable from a first position above and clear of the layer of product, the pallet, or the layer of product on the pallet to a second position over and enclosing the layer of product, the pallet, or the layer of product on the pallet; paddles mounted on internal sides of the frame, each paddle moveable from a first position in which the paddle is clear of the layer of product, if present, to a second position in which the paddle engages and grips a respective side of the layer of product, if present, by applying mechanical force thereto; a vacuum duct mounted in the frame over the layer of product, if present, the vacuum duct moveable from a first position in which the vacuum duct is clear of the layer of product, if present, to a second position in which the vacuum duct engages and grips a top of the layer of product, if present, by applying vacuum force thereto; a pallet support mounted on a base of the frame, the pallet support moveable from a first position in which the pallet support is clear of the pallet, if present, to a second position in which the pallet support is under a horizontal surface of the pallet, if present; and, a control system adapted to selectively control respective mechanisms for positioning of the frame, paddles, vacuum duct, and pallet support to thereby pick and place the layer of product, the pallet, or the layer of product on the pallet.

According to another aspect of the invention, there is provided a system for assembling an order stack, comprising: an infeed adapted to receive first and second source stacks, the first source stack including layers of a first product, the second source stack including layers of a second product; a robot for moving the first and second source stacks from the infeed to respective first and second locations within a storage area; an outfeed adapted to receive layers of product for the order stack; a control system adapted to receive an order specifying a number of layers of the first product and a number of layers of the second product for the order stack and to control the robot to: pick the number of layers of the first product from the first source stack at the first location in the storage area and place the number of layers of the first product on the outfeed; and, pick the number of layers of the second product from the second source stack at the second location in the storage area and place the number of layers of the second product on the number of layers of the first product on the outfeed to thereby assembly the order stack.

According to another aspect of the invention, there is provided a method for assembling an order stack, comprising: receiving first and second source stacks from an infeed, the first source stack including layers of a first product, the second source stack including layers of a second product; moving the first and second source stacks from the infeed to respective first and second locations within a storage area using a robot; receiving at a control system an order specifying a number of layers of the first product and a number of layers of the second product for the order stack; and, controlling the robot with the control system to: pick the number of layers of the first product from the first source stack at the first location in the storage area and place the number of layers of the first product on an outfeed; and, pick the number of layers of the second product from the second source stack at the second location in the storage area and place the number of layers of the second product on the number of layers of the first product on the outfeed to thereby assembly the order stack.

In accordance with further aspects of the present invention there is provided an apparatus such as a control system or data processing system, a method for adapting these, as well as articles of manufacture such as a computer readable medium or product having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a perspective view illustrating a system for layer picking and order fulfillment for items stored in a warehouse in accordance with an embodiment of the invention;

FIG. 2 is a perspective view illustrating a gantry robot and vertical tool of the system in accordance with an embodiment of the invention;

FIG. 3 is a front view illustrating the gantry robot of FIG. 2 with the enclosure removed from the vertical tool and with the vertical tool in a fully raised position in accordance with an embodiment of the invention;

FIG. 4 is a bottom perspective view illustrating the gantry robot of FIG. 2 with the enclosure removed from the vertical tool and with the vertical tool in a partially lowered position in accordance with an embodiment of the invention;

FIG. 5 is a top perspective view illustrating the gantry robot of FIG. 2 with the enclosure removed from the vertical tool and with the vertical tool in a fully lowered position over a stack of product in accordance with an embodiment of the invention;

FIG. 6 is a front view illustrating the vertical tool with the enclosure removed in accordance with an embodiment of the invention;

FIG. 7 is a left side view of the vertical tool of FIG. 6;

FIG. 8 is a rear view of the vertical tool of FIG. 6

FIG. 9 is a right side view of the vertical tool of FIG. 6;

FIG. 10 is a right side perspective view of the vertical tool of FIG. 6;

FIG. 11 is a left side perspective view of the vertical tool of FIG. 6;

FIG. 12 is a left side perspective view of a base of the vertical tool of FIG. 6;

FIG. 13 is a right side perspective view of the base of the vertical tool of FIG. 6;

FIG. 14 is a right side perspective view illustrating the vertical tool (enclosure removed) engaging layers of product in a stack with its vacuum duct and gripping paddles in accordance with an embodiment of the invention;

FIG. 15 is a bottom perspective view illustrating the vertical tool (enclosure removed) lifting layers of product in a stack with its vacuum duct and gripping paddles in accordance with an embodiment of the invention;

FIG. 16 is a bottom perspective view illustrating the vertical tool (enclosure removed) with its safety support belts extended in accordance with an embodiment of the invention;

FIG. 17 is a bottom perspective view illustrating the vertical tool (enclosure removed) engaging a pallet with its pallet supports in accordance with an embodiment of the invention;

FIG. 18 is a bottom perspective view illustrating the vertical tool (enclosure removed) lifting a pallet and stack of product with its vacuum duct and pallet supports in accordance with an embodiment of the invention; and,

FIG. 19 is a block diagram illustrating a data processing system in accordance with an embodiment of the invention.

It will be noted that throughout the appended drawings, like features are identified by like reference numerals.

### DETAILED DESCRIPTION OF THE PREFERRED EMBODIMENTS

In the following description, details are set forth to provide an understanding of the invention. In some instances, certain software, circuits, structures and methods have not been described or shown in detail in order not to obscure the invention. The term “data processing system” is used herein to refer to any machine for processing data, including the computer systems, control systems, and network arrangements described herein. Aspects of the present invention may be implemented in any computer programming language provided that the operating system of the data processing system provides the facilities that may support the requirements of the present invention. Any limitations presented would be a result of a particular type of operating system or computer programming language and would not be a limitation of the present invention. Aspects of the present invention may also be implemented in hardware or in a combination of hardware and software.

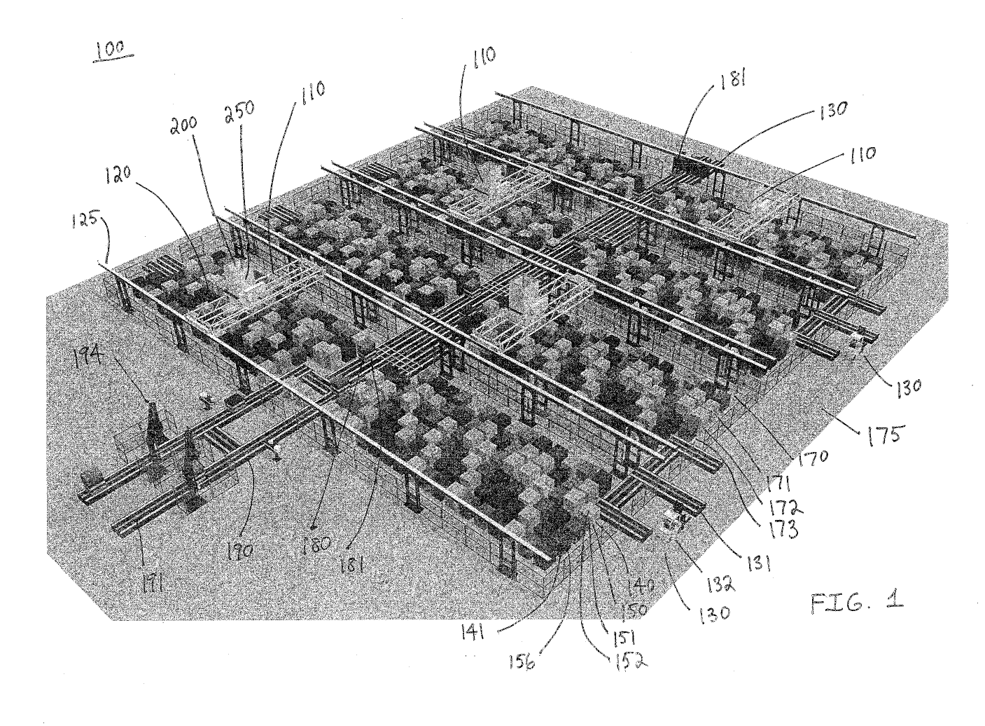

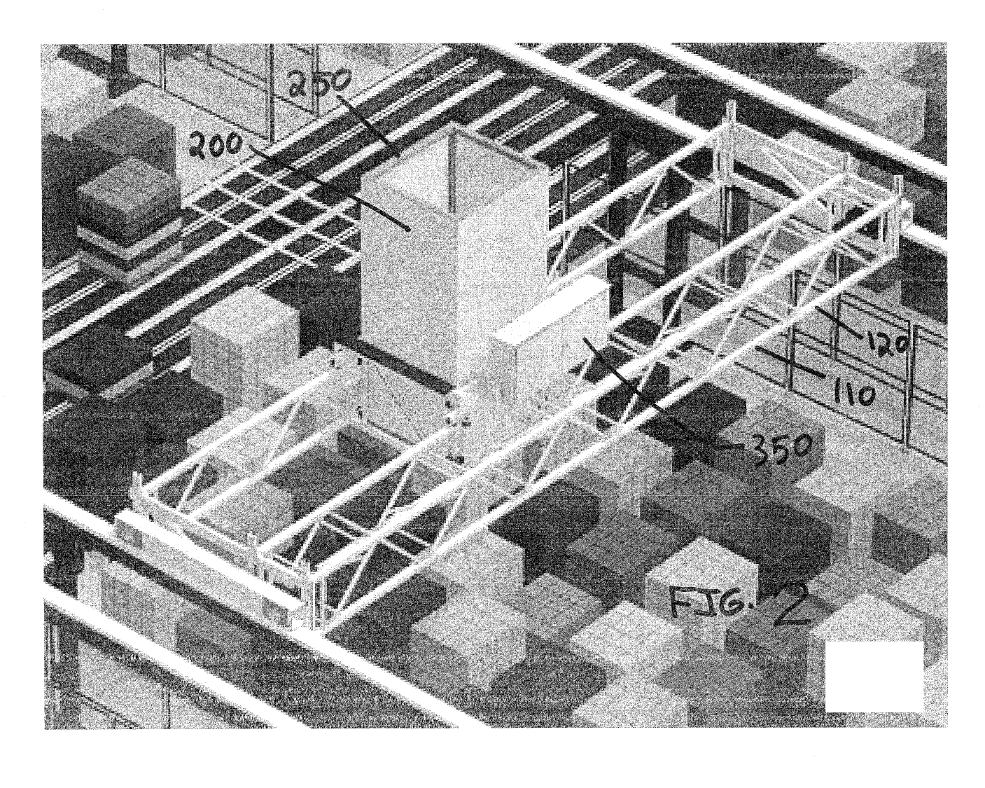

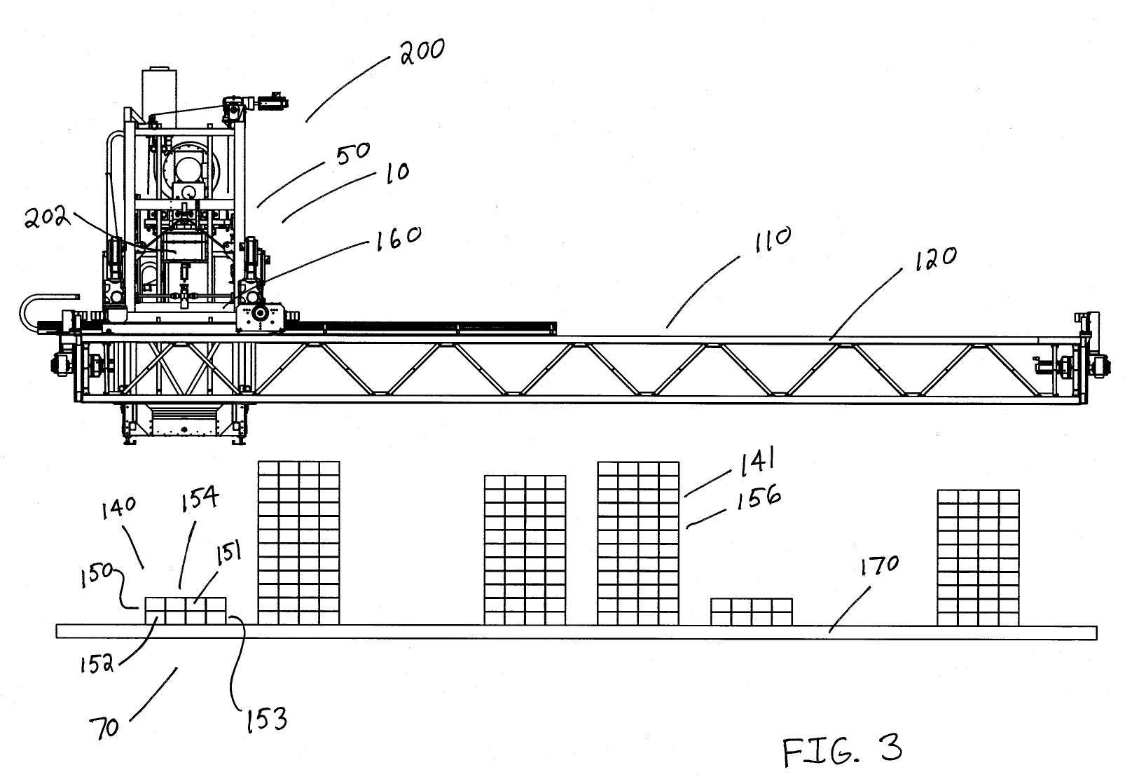

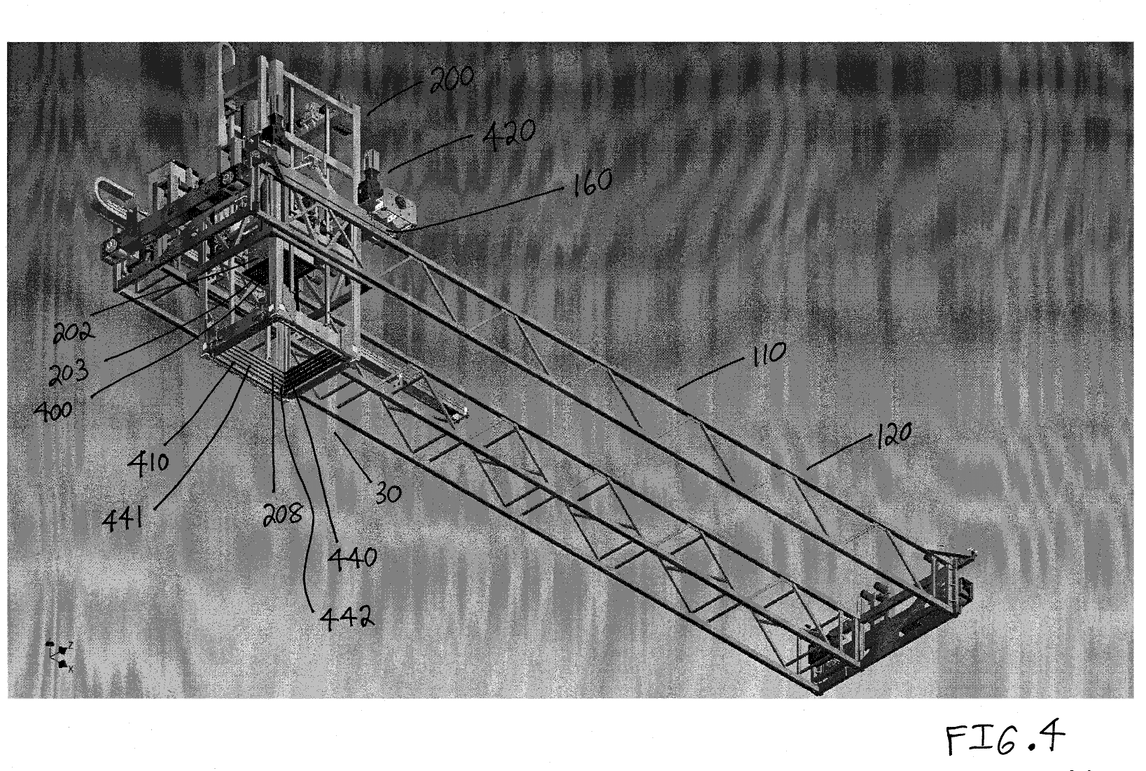

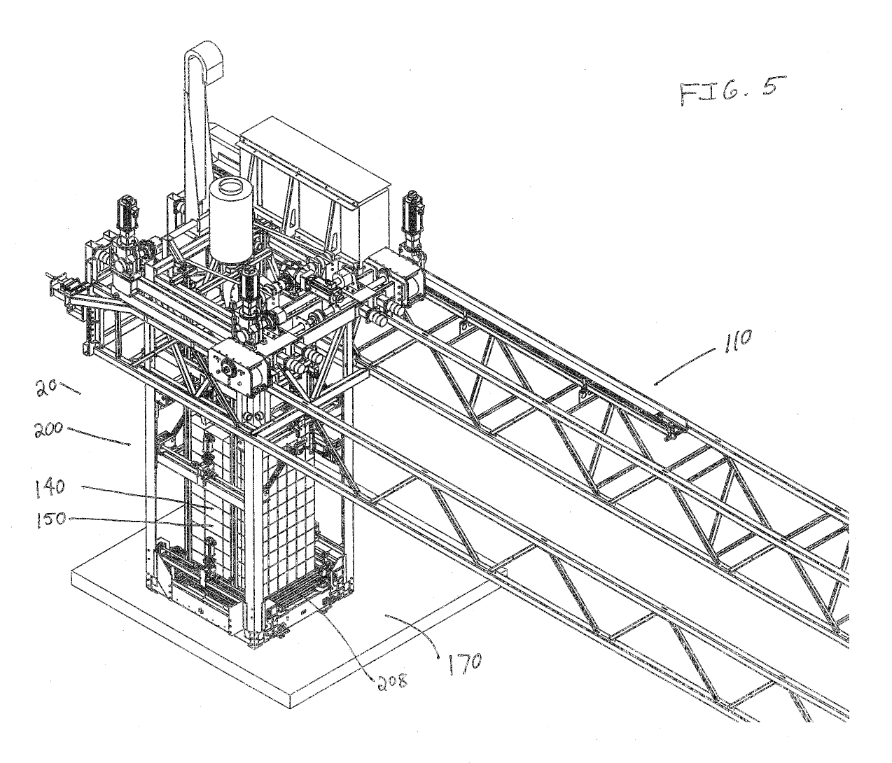

FIG. 1 is a perspective view illustrating a system 100 for layer 151 picking and order 180 fulfillment for items 152 stored in a warehouse 175 in accordance with an embodiment of the invention. FIG. 2 is a perspective view illustrating a gantry robot 110 and vertical tool 200 of the system 100 in accordance with an embodiment of the invention. FIG. 3 is a front view illustrating the gantry robot 110 of FIG. 2 with the enclosure 250 removed from the vertical tool 200 and with the vertical tool 200 in a fully raised position in accordance with an embodiment of the invention. FIG. 4 is a bottom perspective view illustrating the gantry robot 110 of FIG. 2 with the enclosure 250 removed from the vertical tool 200 and with the vertical tool 200 in a partially lowered position in accordance with an embodiment of the invention. And, FIG. 5 is a top perspective view illustrating the gantry robot 200 of FIG. 2 with the enclosure 250 removed from the vertical tool 200 and with the vertical tool 200 in a fully lowered position over a stack 140 of product 150 in accordance with an embodiment of the invention.

The system 100 is configured to physically build outgoing orders or order stacks 180 in a layer quantity, palletized product, multi-sku environment. The system 100 includes at least one large area gantry robot 110 with either a single bridge 120 or multiple bridges. In FIG. 1, the single bridge 120 of the gantry robot 110 spans a pair of elevated rails or gantry 125. The gantry robot 110 is configured to reach or access an infeed 130 or multiple infeeds which introduce stacks (or pallets with stacks on them) 140 containing a single product 150 into the system 100. The infeed 130 may include a conveyor belt 131. Multiple stacks 140, 141 of product 150, 156 are arranged in a grid 171 on the floor 170 or on a deck of the warehouse 175 underneath the gantry robot 110 that act as source stacks 140, 141 for orders or order stacks 180 to be built or assembled by the system 100. Each source stack 140, 141 consists of layers 151 of items 152 of a single product 150, 156 which may be identified by a stock-keeping unit (“SKU”) number or code. A SKU is a number or code used to identify each unique product or item that is stored in the warehouse for sale in a store or other business. There may be single or multiple instances or locations 172, 173 of a particular product 150 in the grid 171. A layer 151 may include a single item 152 of a product 150 or a single product 150 or multiple items 152 of a product 150.

According to one embodiment of the invention, each grid position or location 172, 173 may contain two levels with each level containing a source stack 140 and each of these source stacks 140 may be a different product (or SKU) 150. This second level may be created by placing the second level directly on the first level or it may be created by placing a moveable stack support over the first level that takes the load of the second level down to the floor 170.

The system 100 also includes an outfeed 190 or multiple outfeeds where stacks or pallets of either homogeneous (i.e., single or multiple layers of product with each layer being a homogenous product) or “rainbow” layered product (i.e., single or multiple layers of product with each layer being a homogenous product but with one or more layers being different) forming part of a customer order stack, order pallet, or order 180 exit the system 100. The outfeed 190 may include a conveyor belt 191. Each order 180 may be placed on a pallet 181. An order 180 may be build up on a pallet 181 as the pallet 181 is conveyed through the system 100 via conveyor belt 191 to the outfeed 190.

According to one embodiment, the orders 180 may be created and stored underneath the robot 110 prior to being placed on the outfeed 190. Accordingly to one embodiment, orders 180 may be created on an outfeed 190 just prior to the order 180 exiting the system 100. Accordingly to one embodiment, a single order 180 may receive layers 151 from multiple gantry robots 110 as the order 180 moves between robots 110 to gain access to the grid locations 172, 173 that contain all the products 150, 156 required for that order 180. According to one embodiment, an order 180 may be reverse picked. This means that a source stack 140 becomes the order stack 180 and additional layers 151 of items 152 of a product 150 may be added to the top of the order 180.

The gantry robot 110 includes a multi-functional vertical tool 200 mounted on a carriage 160 on the bridge 120. The vertical tool 200 operates along a vertical axis (e.g., the z-axis) through the carriage 160 and is configured to perform the following functions: gripping and lifting single or multiple layers 151 of product 150 with a mechanical gripper 208, or a mechanical gripper 208 with a vacuum assist 202, or both; gripping and lifting either an empty or full pallet 181 or a pallet 181 with a stack 140 including multiple layers 151 of product 150 on it while maintaining a force on the top layer to prevent shifting of product 150 during movement; gripping and lifting an individual tier or slip sheet; and, catching falling product 150. The vertical tool 200 is housed in an enclosure 250. The bridge 120 may be moved along the gantry 125 for operating along a first horizontal axis (e.g., the x-axis). In FIG. 1, each of the four robots 110 shown is located at different position along its respective gantry 125. The carriage 160 may be moved along the bridge 120 for operating along a second horizontal axis (e.g., the y-axis). In FIG. 2, the carriage 160 and vertical tool 200 are shown in a middle position along the bridge 120. In FIG. 3, the carriage 160 and vertical tool 200 are shown in an end position along the bridge 120. In addition, the vertical tool 200 may be raised and lowered with respect to the bridge 120 of the robot 110. In FIGS. 2 and 3, the vertical tool 200 is shown in a fully raised position. In FIG. 4, the vertical tool 200 is shown in a partially lowered position. And, in FIG. 5, the vertical tool 200 is shown in a fully lowered position. Various mechanisms may be used to position the bridge 120 of the robot 110 along the gantry 125 (i.e., x-axis positioning), the carriage 160 along the bridge 120 (i.e., y-axis positioning), and the vertical tool 200 along the vertical with respect to the bridge 120 (i.e., z-axis positioning). These mechanisms may include electric motors (e.g., servo motors, stepping motors, etc.) and related equipment (e.g., pulleys, belts, gears, rods, etc.) which may be controlled by the control or data processing system 300. According to one embodiment, the vertical tool 200 may be mounted directly to the bridge 120 allowing for positioning along only the z-axis and x-axis. In this case, the robot 110 may be referred to as a linear gantry robot rather than as an area gantry robot.

The system 100 includes a control system or data processing system 300 that is configured to perform the following functions: control the motion of the robot 110 and other system components (e.g., conveyor belts 191, etc.); keep track of where 172, 173 product 150, 156 is located within the grid 170; keep track of product layer 151 characteristics and appropriate handling techniques for each product 150, 156; process orders 180 consisting of single or multiple layers 151 of product 150; request restock quantities when required or in anticipation of being required; control an optional pallet dispenser/accumulator 193 to buffer the supply of pallets 181 to the system 100; and, control an optional order wrapping device 194 for wrapping complete orders 180.

The vertical tool 200 and the control system or data processing system 300 of the system 100 are described in more detail in the following.

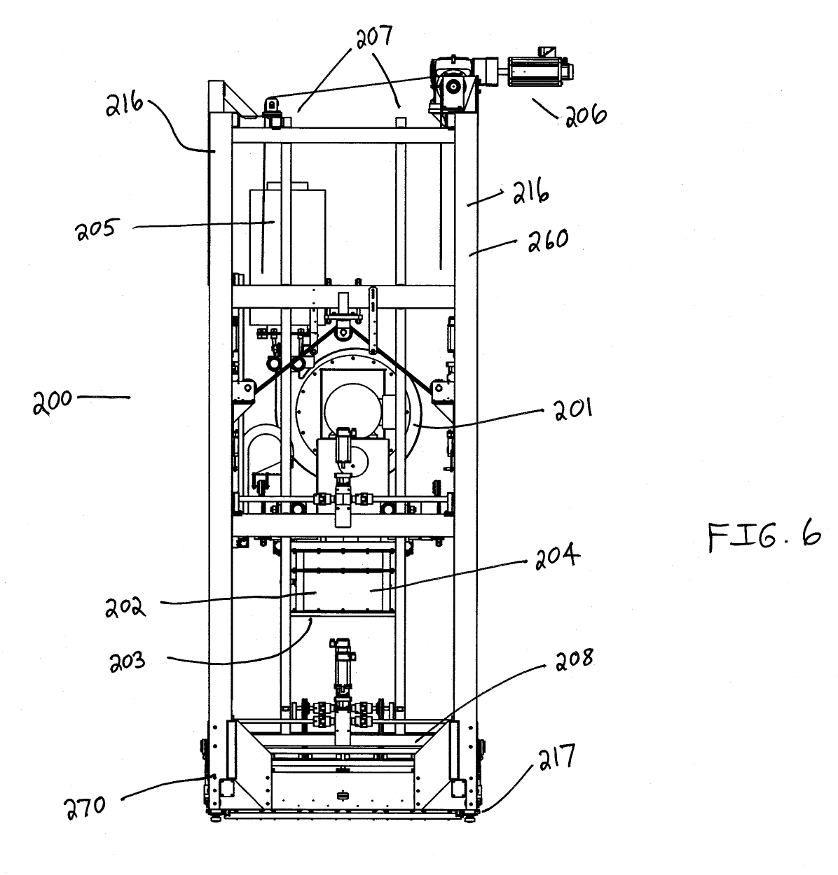

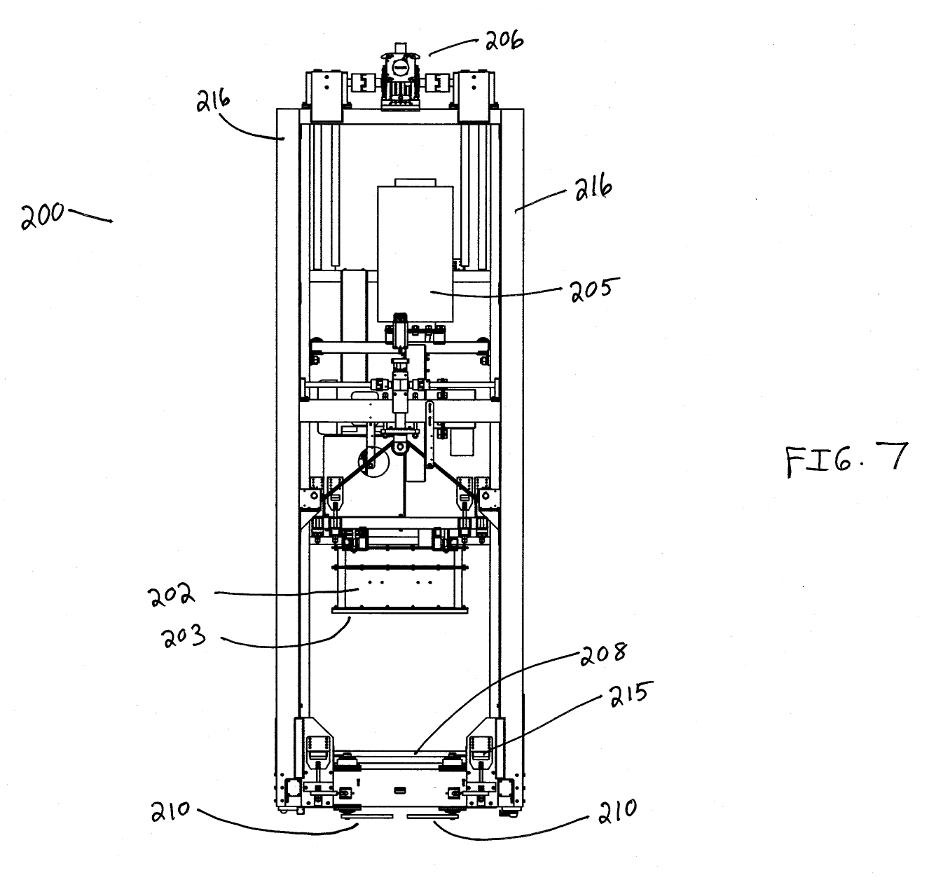

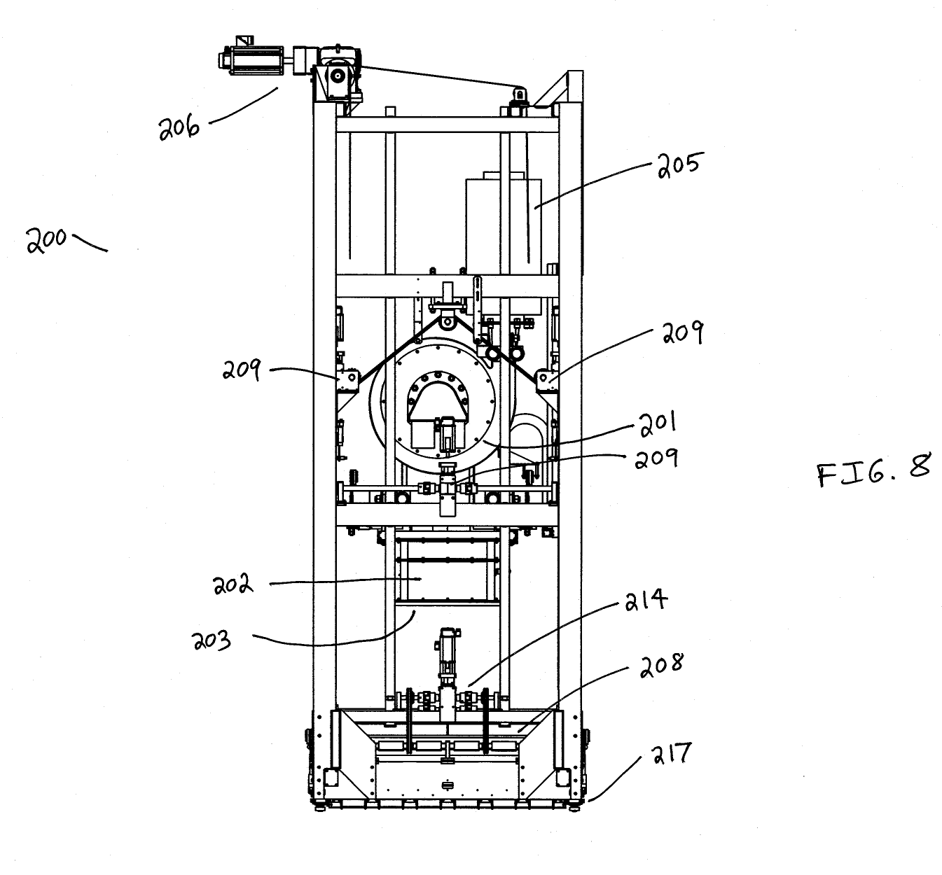

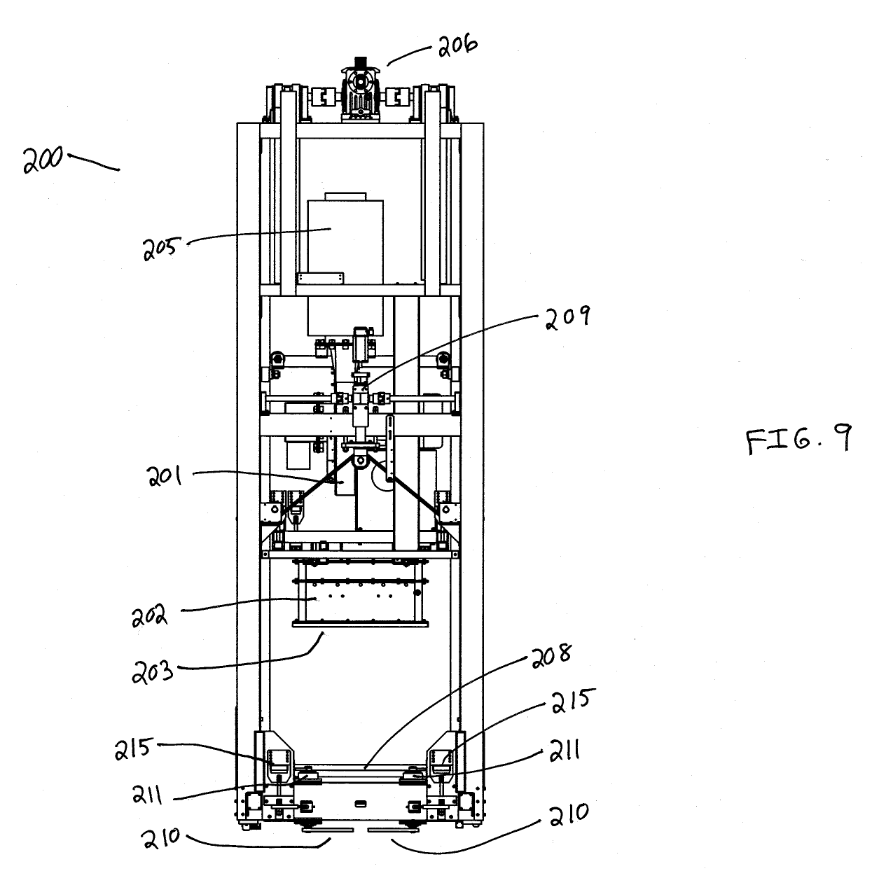

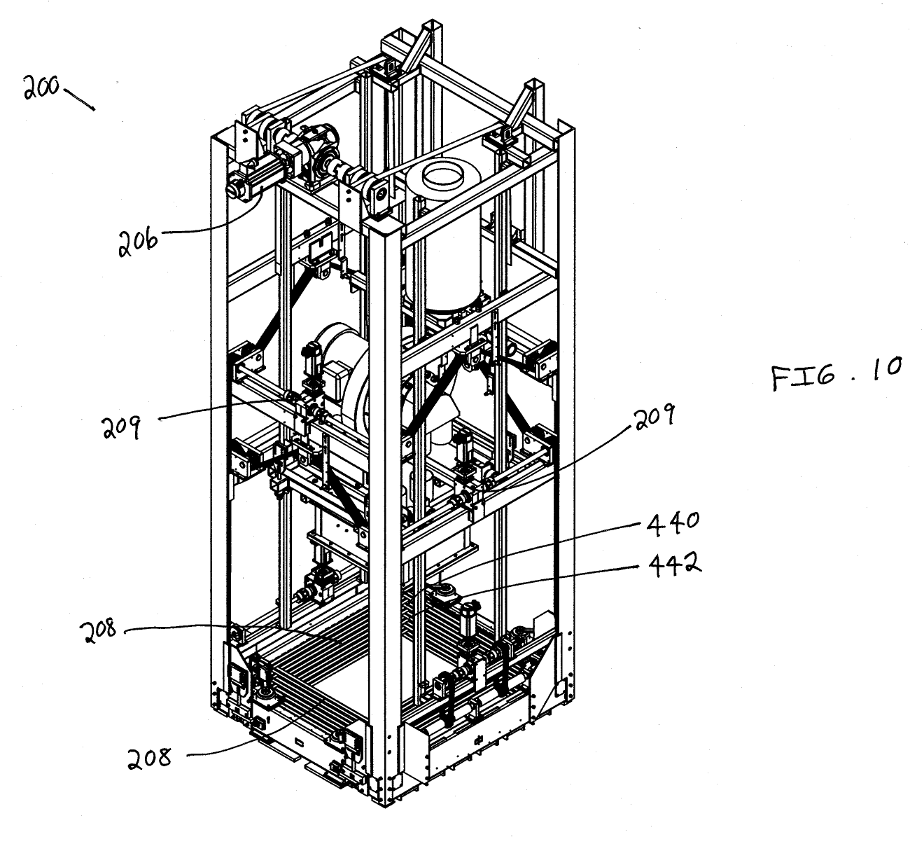

FIG. 6 is a front view illustrating the vertical tool 200 with the enclosure 250 removed in accordance with an embodiment of the invention. FIG. 7 is a left side view of the vertical tool 200 of FIG. 6. FIG. 8 is a rear view of the vertical tool 200 of FIG. 6. FIG. 9 is a right side view of the vertical tool 200 of FIG. 6. FIG. 10 is a right side perspective view of the vertical tool 200 of FIG. 6.

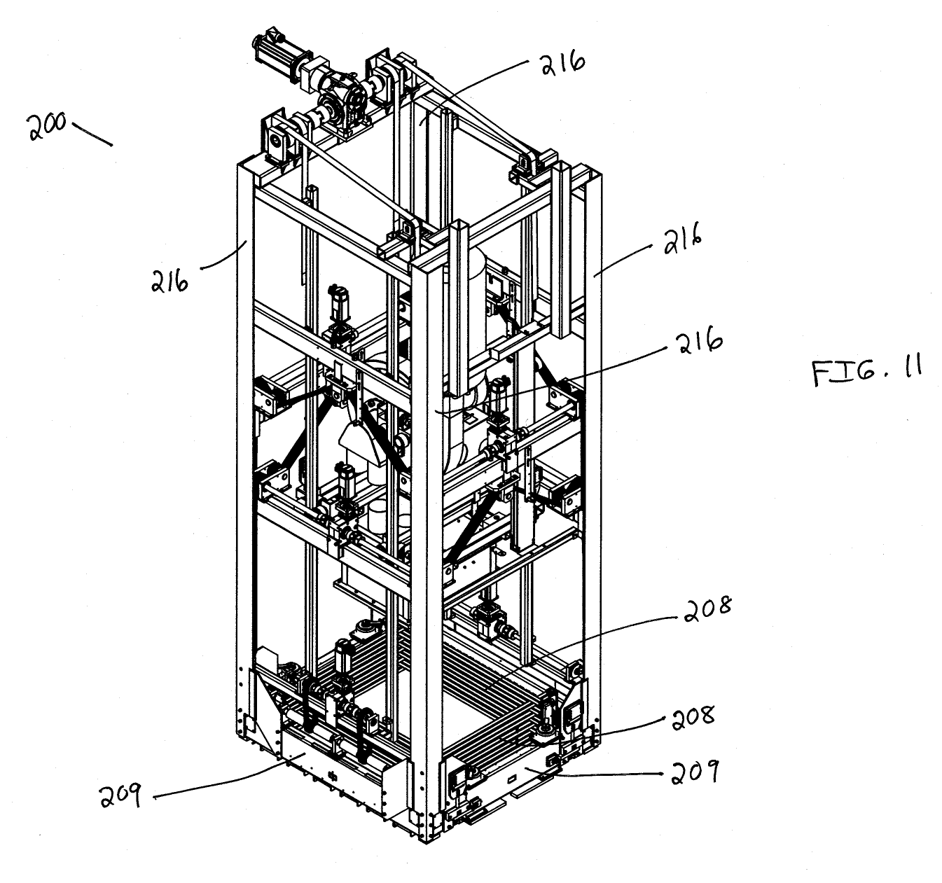

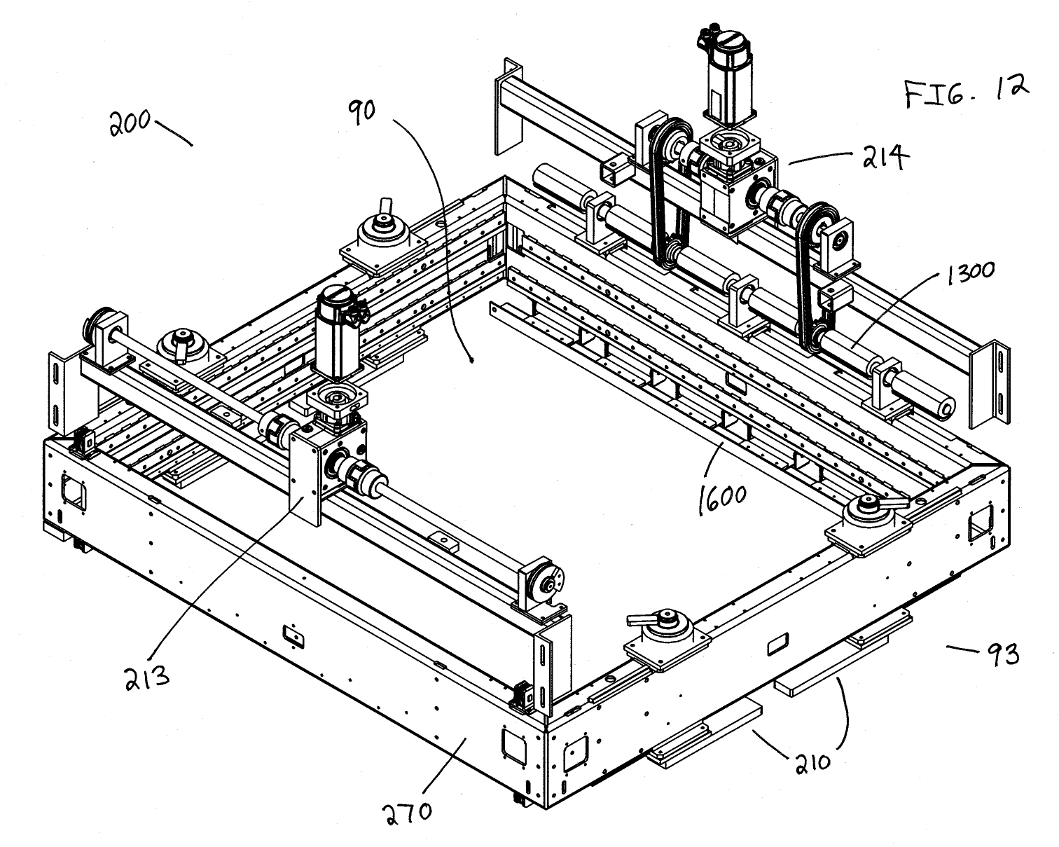

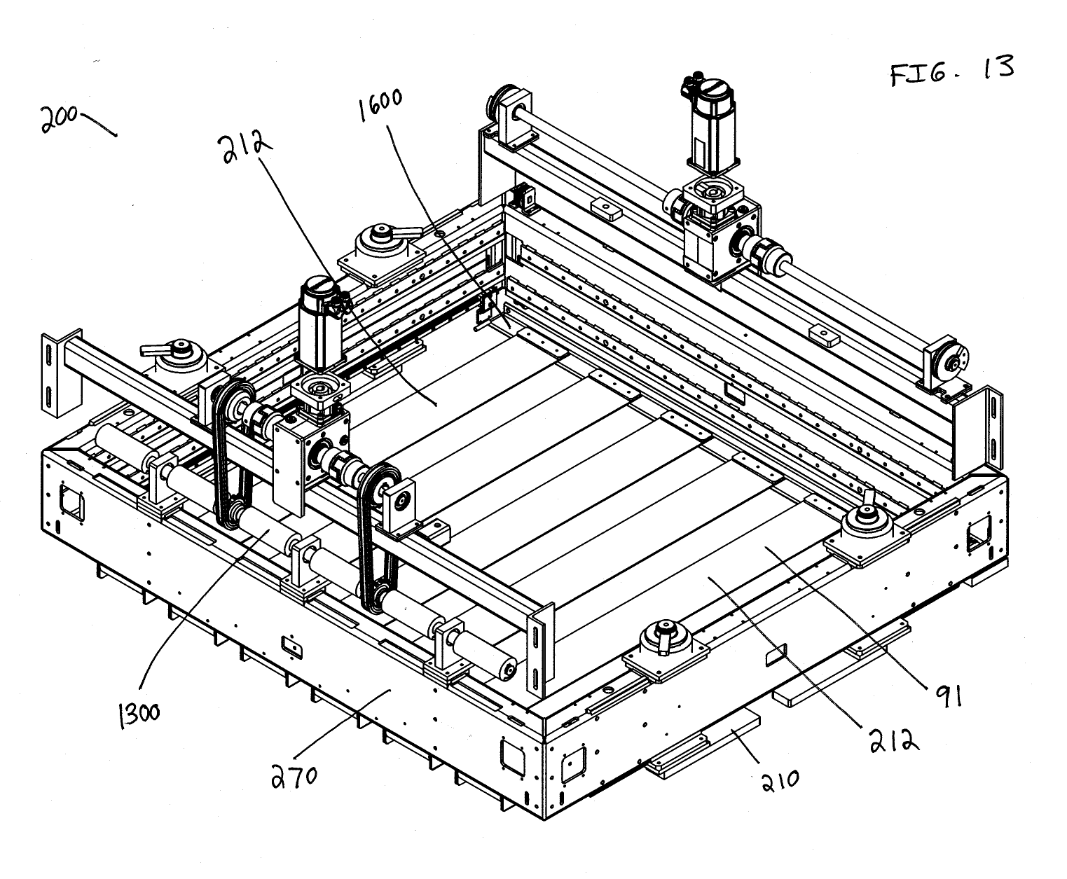

FIG. 11 is a left side perspective view of the vertical tool 200 of FIG. 6. FIG. 12 is a left side perspective view of a base 270 of the vertical tool 200 of FIG. 6. And, FIG. 13 is a right side perspective view of the base 270 of the vertical tool 200 of FIG. 6.

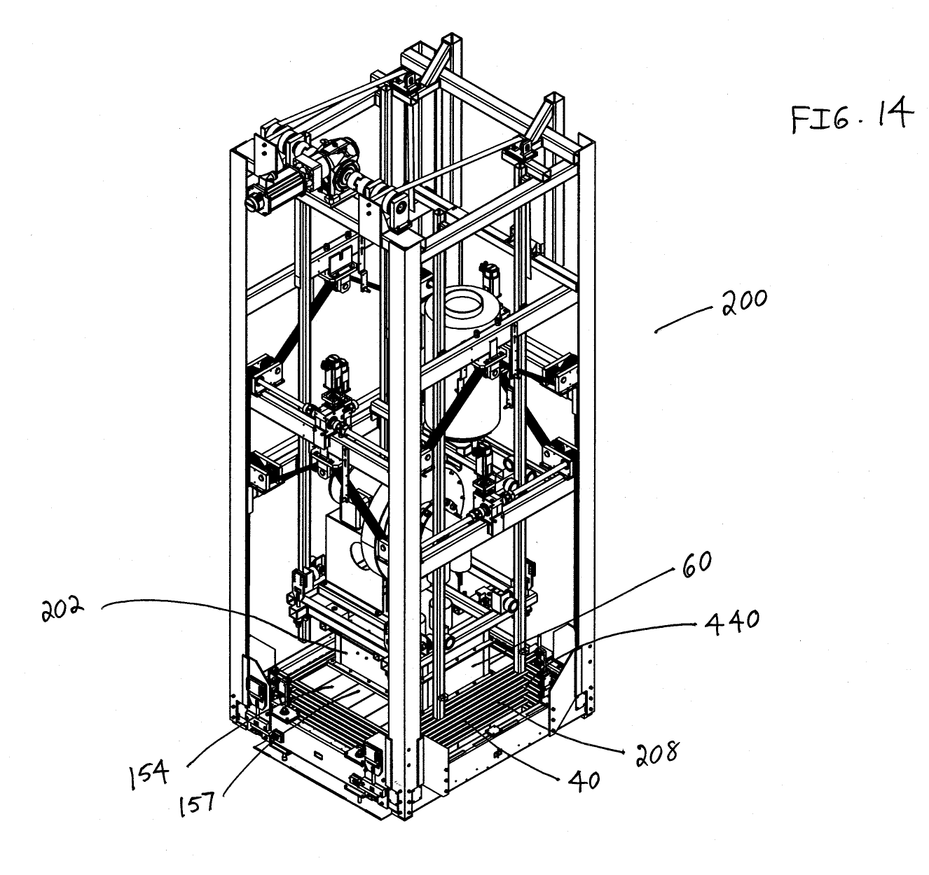

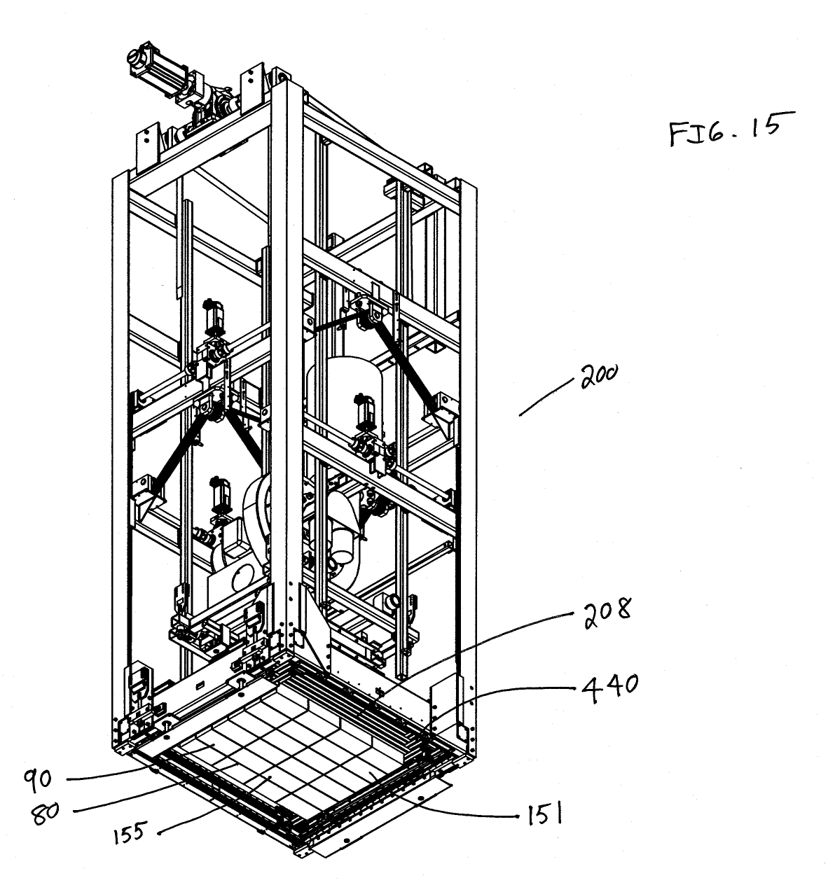

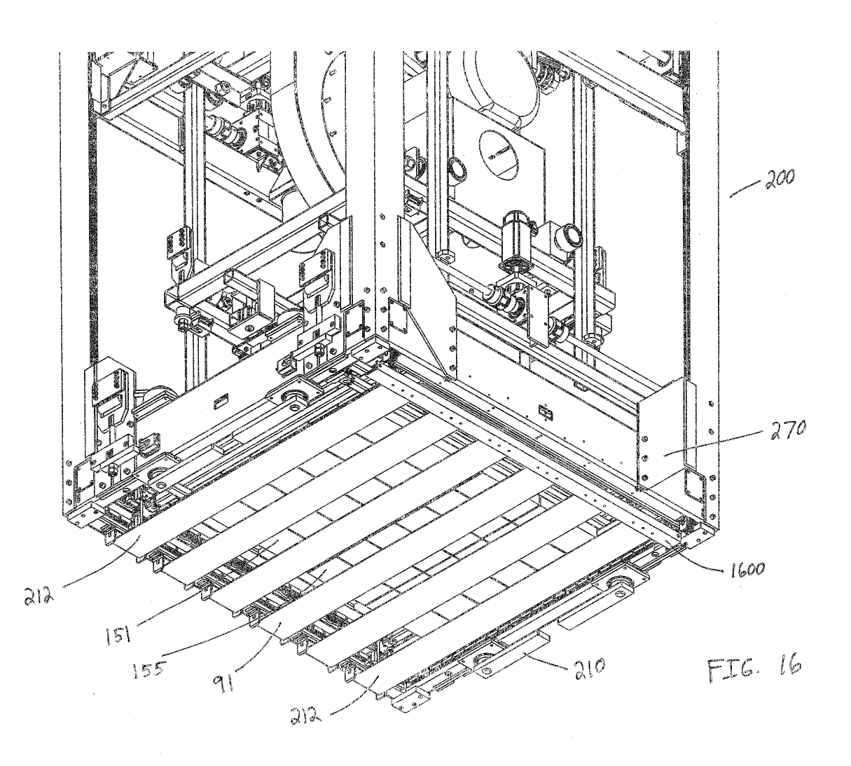

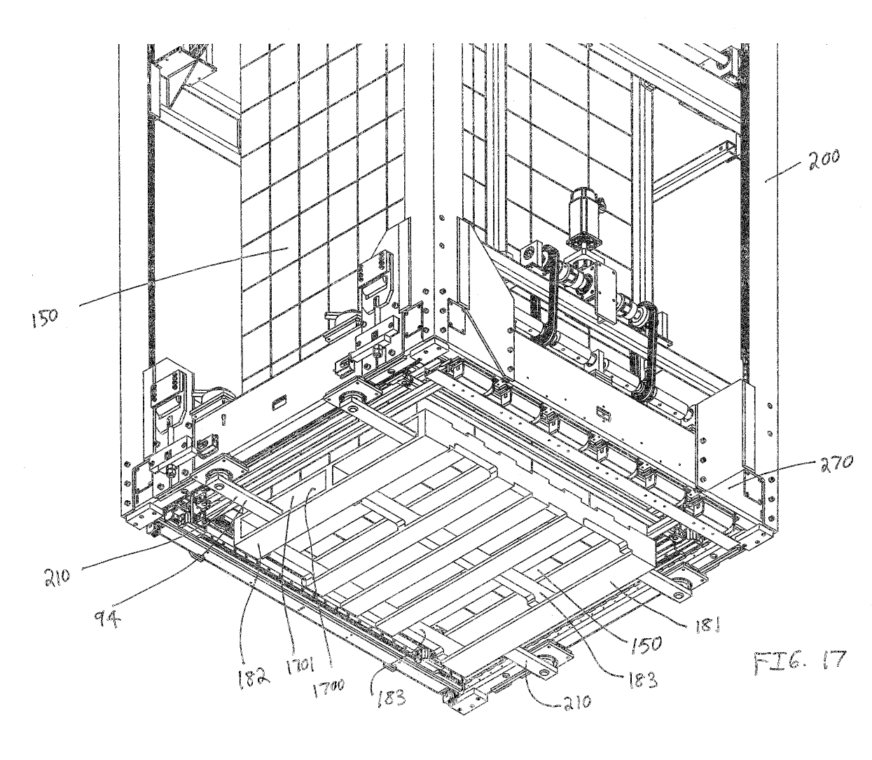

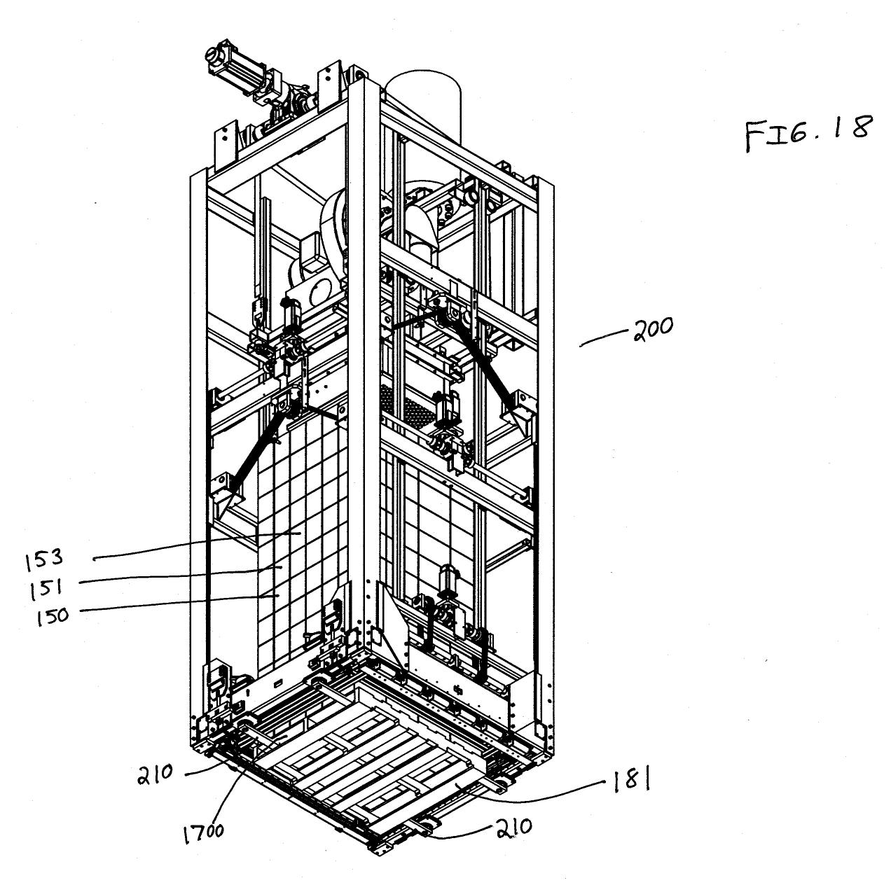

FIG. 14 is a right side perspective view illustrating the vertical tool 200 (enclosure 250 removed) engaging layers 151 of product 150 in a stack 140 with its vacuum duct 202 and gripping paddles 208 in accordance with an embodiment of the invention. FIG. 15 is a bottom perspective view illustrating the vertical tool (enclosure 250 removed) 200 lifting layers 151 of product 150 in a stack 140 with its vacuum duct 202 and gripping paddles 208 in accordance with an embodiment of the invention. FIG. 16 is a bottom perspective view illustrating the vertical tool (enclosure 250 removed) 200 with its safety support belts 212 extended in accordance with an embodiment of the invention. FIG. 17 is a bottom perspective view illustrating the vertical tool (enclosure 250 removed) 200 engaging a pallet 181 with its pallet supports 210 in accordance with an embodiment of the invention. And, FIG. 18 is a bottom perspective view illustrating the vertical tool (enclosure 250 removed) 200 lifting a pallet 181 and stack 140 of product 150 with its vacuum duct 202 and pallet supports 210 in accordance with an embodiment of the invention.

According to one embodiment, the vertical tool 200 includes a frame 260 which is mounted within an enclosure 250 (not shown in FIG. 2) and on which are mounted the various components of the vertical tool 200. The enclosure 250 may consist of panels fastened to each side of the frame 260. The vertical tool 200 may include tool guidance bars 216 (e.g., 4 bars) to control the side-to-side and rotational position of the tool 200 relative to the gantry robot 110 as the tool 200 is repositioned or moved. The frame 260 includes the tool guidance bars 216, base 270, and other supporting members. The vertical tool 200 may include tool hoisting points 215 which are the points from which the entire tool 200 is vertically supported when it is lifted by the gantry robot 110. When the hoisting points 215 are moved vertically, the entire tool 200 moves vertically relative to the bridge 120. A mechanism mounted 420 on the carriage 160 may be used to raise and lower the tool 200. This mechanism 420 may include electric motors (e.g., servo motors, stepping motors, etc.) and related equipment (e.g., pulleys, belts, gears, rods, etc.) which may be controlled by the control or data processing system 300.

According to one embodiment, the vertical tool 200 may include a vacuum plenum or duct 202 that is adapted to move vertically within the vertical tool 200 and which has a vacuum opening or surface 203 on the bottom. The vacuum surface 203 of the duct 202 is generally smaller in dimension (i.e., length and width) than the dimensions (i.e., length and width) of the smallest layer 151 of product 150 that is expected to be handled by the system 100. The vacuum surface 203 may be equipped with a flexible compressible screen pad 400 to provide a seal against the product 150 and to prevent product 150 from being drawn into the vacuum duct 202. The screen pad 400 may be made of a rubber material to allow it to conform to the surface of the top 154 of a layer 151. The variable positioning of the vacuum duct 202 within the tool 200 can be seen in FIGS. 5-6, for example. A source or generator of variable vacuum 201 is mounted on the duct 202, frame 260, or gantry robot 110 and it draws air from the duct 202 to create a vacuum therein. The duct 202 is mounted in the vertical tool 200 at a height relative to the gripping paddles 208 such that the vacuum surface 203 provides support to the central region 157 of the top 154 of a layer 151 to reduce slipping or shifting that could occur if just the mechanical gripping paddles 208 were used to pick the layer 151. Alternatively, the duct 202 can be located at a height to supply a load on the top layer 151 of a full or partial pallet 140 so that product 150 does not shift during movement of the tool 200. The duct 202 may include vacuum cups suitable to pick up a tier sheet or a slip sheet in a source stack 140. For reference, a tier sheet is flat sheet of somewhat flexible material (normally either plastic or paper) that is used to tie a load of product together by sandwiching the sheet between layers of product as the load is created. A slip sheet is a flat sheet of material that is used underneath a load of product that is used to either help bind a load together or to allow the load to be pulled across a surface by gripping the sheet. Sometimes it is used in commercial shipping to eliminate the need for a traditional pallet 181 during shipping. Between the vacuum generator 201 and the vacuum surface 203 is a vacuum valve 204 (e.g., located inside the duct 202) which is configured to turn the vacuum generator 201 off and release the grip on the central area 157 of the layer 151. This valve 204 may also be used to control the vacuum flow. The vertical tool 200 may include a vacuum silencer 205 to reduce the sound of the vacuum generator 201. The vacuum silencer 205 may be obtained from a third party or may be custom built to use space within the tool 200 more effectively. The vertical tool 200 may include vacuum duct guidance bars 207 mounted to the frame 260 to control the side-to-side and rotational position of the vacuum duct 202 relative to the tool 200 as the duct 202 is repositioned or the gantry robot 110 is moved. The vertical tool 200 may include a vacuum duct lifting mechanism 206 to reposition the vacuum duct 202 vertically within the frame 260 and along the guidance bars 207 relative to the bottom 155 of a layer 151. The mechanism 206 may include electric motors (e.g., servo motors, stepping motors, etc.) and related equipment (e.g., pulleys, belts, gears, rods, etc.) which may be controlled by the control or data processing system 300. Vertical positioning of the duct 202 within the tool 200 is necessary to accommodate layers 151 of different height or to create space to accept an entire pallet 181 filled with multiple layers 151 of product 150 into the tool 200 (see FIG. 5). This mechanism 206 is also used to place the duct 202 on top of a load when transporting a pallet 181 to reduce the chances of case or product 150 movement.

According to one embodiment, as shown in FIGS. 4 and 14, the vertical tool 200 may include interwoven gripping paddles 208 (e.g., 4 sets of 5) that grip all four sides (or selected sides) 153 of a layer 151 in a source stack 140 at a fixed position within the vertical tool 200. The gripping paddles 208 may be mounted near the base 270 of the tool 200. Each inner side 410 of the tool 200 may be equipped with a set of gripping paddles 208. Each paddle 208 may be an independently mounted horizontal bar 441. The ends 442 of each set of paddles 208 on an inner side 410 of the tool 200 may be interwoven 440 with the ends 442 of adjacent sets of paddles 208 on adjacent sides 410 of the tool 200. The interleaving 440 of paddles 208 improves the gripping performance of the tool 200. It also allows for layers 151 of different dimensions to be gripped. The vertical tool 200 may include a layer gripping and force generation mechanism 209 to move the gripping paddles 208 into and out of contact with the layers 151 and to generate sufficient force to actually grip the product 150 from the sides 153. The mechanism 209 may include electric motors (e.g., servo motors, stepping motors, etc.) and related equipment (e.g., pulleys, belts, gears, rods, etc.) which may be controlled by the control or data processing system 300.

According to one embodiment, as shown in FIG. 16, the vertical tool 200 may include safety support belts 212 (e.g., 6 belts) or a surface that extends below the base 270 of the tool 200 so that in the unlikely event that an item 152 of product 150 falls during lifting it may be caught so that the floor 170 or grid 171 is not disturbed below the robot 110. The vertical tool 200 may include a product safety support belt advancement mechanism 213 to pull a series of belts 212 underneath the layer 151 (i.e., while the tool 200 maintains a gap between the belts 212 and the product 150). The belts 212 may be coupled to an angle or bar 1600 at one end and to respective spools 1300 at the opposite end. The spools 1300 may be mounted on one outer side of the tool 200. The purpose of the belts 212 is to catch any product 150 that dislodges from the layer 151 when it is lifted by the tool 200. This helps avoid a potentially messy cleanup of product 150 in the work envelope of the gantry 110. The belt advancement mechanism 213 is activated after the tool 200 has generated a gap between the product 150 being lifted (e.g., by the vacuum duct 202) and the surface from which it is being lifted (e.g., a pallet 181). The belt advancement mechanism 213 pulls on the bar 1600 to unwind the belts 212 from their respective spools 1300 and to draw them across the bottom 155 of the bottom layer 151 of product 150 lifted by the tool 200. The vertical tool 200 may include a product safety support belt retraction and wind up mechanism 214 to retract the series of belts 212 that have been positioned underneath the bottom layer 151 of product 150 and rewind them on their respective spools 1300. Again, the belts 212 are used to catch any product 150 that drops out of the tool 200. The retraction mechanism 214 is activated just prior to setting down a layer 151 of product 150 on a deposit surface (e.g., a pallet 181). These mechanisms 213, 214 may include electric motors (e.g., servo motors, stepping motors, etc.) and related equipment (e.g., pulleys, belts, gears, rods, etc.) which may be controlled by the control or data processing system 300. In general, the belts 212 are used when layers 151 of product are lifted alone rather than when a pallet 181 is lifted with layers 151 on it.

According to one embodiment, as shown in FIGS. 17-18, the vertical tool 200 may include pallet supports (e.g., four) 210 that can be controlled to enter the forklift blade slots 1700 of a pallet 181 to lift the pallet 181 (e.g., from upper horizontal surface 1701 of the slot 1700). According to another embodiment, the pallet supports 210 may be positioned under the bottom (horizontal surface) 182 of a pallet 181 to lift the pallet 181. In this case, pallets 181 may be elevated from the floor 170 to allow the pallet supports 210 to access the bottoms 182 of the pallets 181. Pallets 181 may be elevated from the floor 170 using horizontal rods or bars, for example. According to another embodiment, pallets 181 handled by the system 100 may be mounted on sub-pallets or fixtures when they enter the warehouse 175. These fixtures may be equipped with features (e.g., lugs, lifting eyes, etc.) that may be engaged by the pallet supports 210 to facilitate lifting by the tool 200. In this case, the pallet 181 would be lifted along with its fixture and hence risks associated with the structural integrity of the pallet 181 may be reduced. The pallet supports 210 may be mounted at a fixed height within the vertical tool 200 or on the base 270 of the tool 200. Two supports 210 may be mounted on two opposite sides of the base 270 of the tool 200. When configured to lift pallets 181 from the bottom 182, the pallet supports 210 may be arranged to support the main stringers 183 of the pallet 181 (e.g., the pallet supports 210 may be mounted on the two unused sides of the base 270 of the tool 200 shown in FIG. 17). The pallet supports 210 allow the tool 200 to lift entire pallets 181 loaded with layers 151 of product 150 and are adapted to carry the load of such layers 151 and pallets 181 when lifted. The vertical tool 200 may include a pallet support mechanism 211 to move the pallet supports 210 into the engaged position so that they can support the pallet 181 and out of the engaged position to allow layers 151 without pallets 181 to be moved. The mechanism 211 may include electric motors (e.g., servo motors, stepping motors, etc.) and related equipment (e.g., pulleys, belts, gears, rods, etc.) which may be controlled by the control or data processing system 300. The pallet supports 210 may be used in combination with the gripping paddles 208 and/or vacuum duct 202 to lift pallets 181 of product 150. The pallet supports 210 may also be used to lift empty pallets 181 and pallets 181 mounted on fixtures.

According to one embodiment, as shown in FIG. 6, the vertical tool 200 may include a sensor ring 217 for detection of failure to lift a complete layer 151 of product 150, failure to maintain grip on a complete layer 151 of product 150, and/or dropping of an item 152 or layer 151 of product 150. If the sensors 217 are triggered, then the system 100 may react in an appropriate way (e.g., inhibiting motion of the robot 110, taking the tool 200 to a recovery area where manual intervention may take place, etc.). Outputs from the sensor ring 217 may be monitored by the control or data processing system 300.

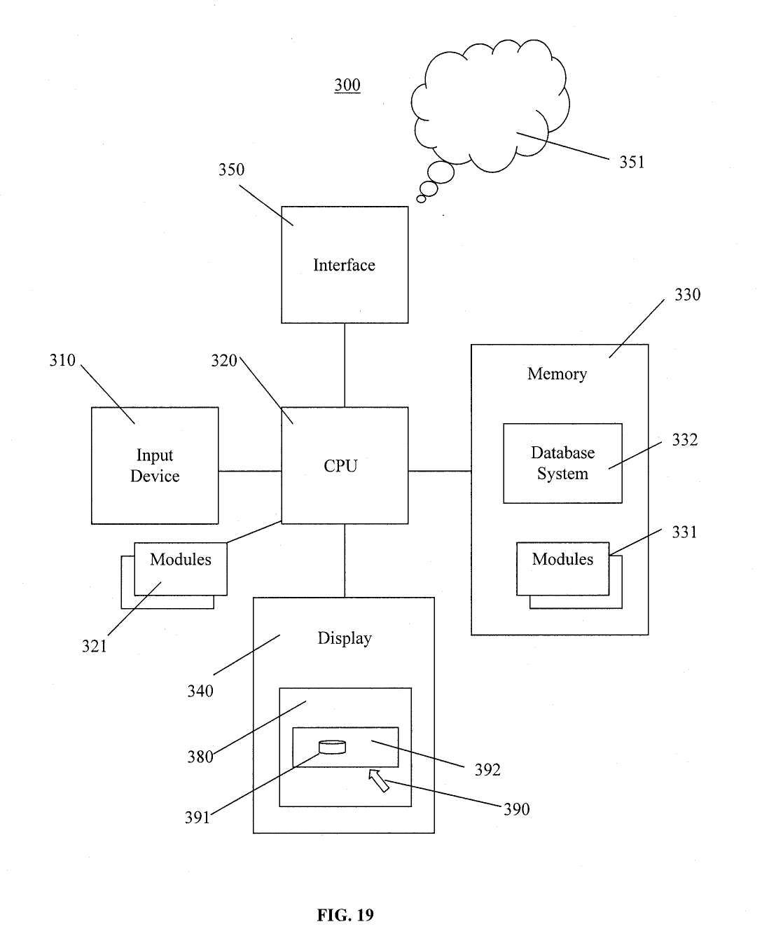

FIG. 19 is a block diagram illustrating a data processing system 300 in accordance with an embodiment of the invention. The data processing system 300 is suitable for controlling the system 100 and its components in conjunction with an optional graphical user interface (“GUI”), as described below. The data processing system 300 may be a client and/or server in a client/server system. For example, the data processing system 300 may be a server system or a personal computer (“PC”) system. The data processing system 300 includes an input device 310, a central processing unit (“CPU”) 320, memory 330, a display 340, and an interface device 350. The input device 310 may include a keyboard, a mouse, a trackball, a touch sensitive surface or screen, a position tracking device, an eye tracking device, or a similar device. The display 340 may include a computer screen, television screen, display screen, terminal device, a touch sensitive display surface or screen, or a hardcopy producing output device such as a printer or plotter. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may be used to operatively couple the data processing system 300 to components of the system 100 such as the controls, motors, and related equipment associated with the robot 110, vertical tool 200, conveyor belts 131, 191, pallet dispenser/accumulator 193, and wrapping device 194. The interface device 350 may include one or more network connections. The data processing system 300 may be adapted for communicating with other data processing systems (e.g., similar to data processing system 300) over a network 351 via the interface device 350. For example, the interface device 350 may include an interface to a network 351 such as the Internet and/or another wired or wireless network (e.g., a wireless local area network (“WLAN”), a cellular telephone network, etc.). As such, the interface 350 may include suitable transmitters, receivers, antennae, etc. Thus, the data processing system 300 may be linked to other data processing systems by the network 351. The CPU 320 may include or be operatively coupled to dedicated coprocessors, memory devices, or other hardware modules 321. The CPU 320 is operatively coupled to the memory 330 which stores an operating system (e.g., 331) for general management of the system 300. The CPU 320 is operatively coupled to the input device 310 for receiving user commands or queries and for displaying the results of these commands or queries to the user on the display 340. Commands and queries may also be received via the interface device 350 and results may be transmitted via the interface device 350. The data processing system 300 may include a database system 332 (or store) for storing data and programming information. The database system 332 may include a database management system and a database and may be stored in the memory 330 of the data processing system 300. In general, the data processing system 300 has stored therein data representing sequences of instructions which when executed cause the method described herein to be performed. Of course, the data processing system 300 may contain additional software and hardware a description of which is not necessary for understanding the invention.

Thus, the data processing system 300 includes computer executable programmed instructions for directing the system 300 to implement the embodiments of the present invention. The programmed instructions may be embodied in one or more hardware modules 321 or software modules 331 resident in the memory 330 of the data processing system 300 or elsewhere (e.g., 320). Alternatively, the programmed instructions may be embodied on a computer readable medium or product (e.g., a compact disk (“CD”), a floppy disk, etc.) which may be used for transporting the programmed instructions to the memory 330 of the data processing system 300. Alternatively, the programmed instructions may be embedded in a computer-readable signal or signal-bearing medium or product that is uploaded to a network 351 by a vendor or supplier of the programmed instructions, and this signal or signal-bearing medium may be downloaded through an interface (e.g., 350) to the data processing system 300 from the network 351 by end users or potential buyers.

A user may interact with the data processing system 300 and its hardware and software modules 321, 331 using a graphical user interface (“GUI”) 380. The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input device 310 such as a mouse. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input device (e.g., a mouse) 310 to position a pointer or cursor 390 over an object (e.g., an icon) 391 and by “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

In operation, referring to FIG. 1, the grid 171 on the floor 170 of the warehouse 175 is pre-charged with sufficient product 150, 156 to satisfy all expected orders 180 or the system 100 may recharge on the fly as orders become visible to it. An order for a particular customer is entered into the system 100 (i.e., into the control or data processing system 300 of the system 100 via the GUI 380 or otherwise) taking into consideration any load rules that may apply (e.g., heavy products on the bottom, light products on the top, etc.). The system 100 determines if there is sufficient inventory underneath the gantry robots 110 to satisfy the order. If there isn't, the system 100 requests that any missing products 150, 156 be introduced into the system 100. When the missing product 150 is introduced to the system 100, either the entire pallet is lifted by the vertical tool 200 and transferred to a selected location 172 in the grid 171 or layers 151 are transferred to a location 172 in the grid 171 to act as a source 140. In general, the gantry robot 110 performs the charging function but other means may also be used (e.g., forklift truck 132). Referring to FIG. 3, when sufficient product 150 is available in the grid 171, the bridge 120 of the robot 110 positions the vertical tool 200 above the desired product source 140. Referring to FIG. 5, the tool 200 lowers over the product 150 and grips the number of layers 151 desired. Referring to FIG. 15, the tool 200 lifts these layers 151 and transfers them either to an empty pallet 181 in the grid 171 or to an empty pallet 181 on the outfeed 190. The tool 200 releases the layers 151 and moves to get the next product 150. This is repeated until either the order 180 is satisfied or the pallet 181 is full. If the entire order 180 has not been satisfied, this process may continue on to another pallet 181 until the order 180 is complete. Referring to FIG. 18, if the order 180 is being staged in the grid 171, then at a suitable time it may be transferred by the gantry robot 110 to the outfeed 190.

The above embodiments may contribute to an improved apparatus 200, system 100, and method for layer picking and order fulfillment for items 152 stored in a warehouse 175 and may provide one or more advantages. First, the system 100 reduces the number of mechanisms required to move source pallets or stacks 140. Second, the system 100 reduces the overall movement of stacks 140 and pallets 181. Third, the system 100 reduces the energy required to move source pallets 140. Fourth, the system 100 reduces floor space consumed in a warehouse 175. Fifth, the system 100 improves throughput. Sixth, the two different and cooperative layer gripping methods (i.e., vacuum duct 202 and gripping paddles 208) of the lifting tool 200 of the system 100 increases the number and type of products that can be handled. Seventh, the system 100 makes it easier and less disruptive to inject a new order into the mix. In most circumstances it does not matter which order is handled next. This makes it possible and just as efficient to build orders in the needed sequence rather than in a pre-optimized sequence. And, eighth, the lifting tool 200 of the system 100 is capable of picking and placing a layer or multiple layers 151 of product 150 as well as picking and placing pallets 181 with or with layers 151 of product 150 on the pallets 181. The lifting tool 200 can be used in just a layer picking mode (e.g., vacuum duct 202 and gripping paddles 208) or in just a pallet picking mode (e.g., pallet supports 210) or in a combination that allows for both modes of use (e.g., vacuum duct 202, gripping paddles 208, and pallet supports 210). As such, the invention provides a single tool 200 that can perform both layer picking and pallet picking functions.

Thus, according to one embodiment, there is provided an apparatus (e.g., a vertical tool 200) for picking (or lifting) and placing (or lowering) a layer 151 of product 150, comprising: a frame 260, the frame 260 movable from a first position 10 above and clear of the layer 151 of product 150 to a second position 20 over and enclosing the layer 151 of product 150; paddles 208 mounted on respective internal sides 410 of the frame 260, each paddle 208 moveable from a first position 30 in which the paddle 208 is clear of the layer 151 of product 150 to a second position 40 in which the paddle 280 engages and grips a respective side 153 of the layer 151 of product 150 by applying mechanical force thereto; a vacuum duct 202 mounted in the frame 260 over the layer 151 of product 150, the vacuum duct 202 moveable from a first position 50 in which the vacuum duct 202 is clear of the layer 151 of product 150 to a second position 60 in which the vacuum duct 202 engages and grips a top 154 of the layer 151 of product 150 by applying vacuum force thereto; and, a control system 300 adapted to selectively control respective mechanisms (e.g., 420, 206, 209) for positioning of the frame 260, paddles 208, and vacuum duct 202 to thereby pick (e.g., lift from a position 70 on a floor 170 or pallet 181 to an elevated position 80) and place (e.g., lower from the elevated position 80 to the position 70 on the floor 170 or pallet 181) the layer 151 of product 150.

The apparatus 200 may further include a belt 212 mounted on the frame 260, the belt 212 movable from a first position 90 in which the belt 212 is clear of a bottom 155 of the layer 151 of product 150 when lifted to a second position 91 in which the belt 212 is extended across the bottom 155 of the layer 151 of product 150 when lifted to thereby prevent items 152 of product 150 from dropping from the layer 151 of product 150 when lifted, and the control system 300 may be further adapted to selectively control a mechanism (e.g., 213, 214) for positioning of the belt 212. The layer 151 of product 150 may be mounted on a pallet 181 and the apparatus 200 may further include a pallet support 210 mounted on a base 270 of the frame 260, the pallet support 210 moveable from a first position 93 in which the pallet support 210 is clear of the pallet 181 to a second position 94 in which the pallet support 210 engages the pallet 181 by entering a forklift blade slot 1700 of the pallet 181, and the control system 300 is further adapted to selectively control a mechanism 211 for positioning of the pallet support 210 to thereby lift the layer 151 of product 150 and the pallet 181. The layer 151 of product 150 may be at least one layer 151 of product 150. Each paddle 208 may be at least two paddles 208. Ends 442 of the at least two paddles 208 on adjacent internal sides 410 of the frame 260 may be interwoven 440. The belt 212 may be at least one belt 212. The pallet support 210 may be at least one pallet support 210 and the forklift blade slot 1700 may be at least one forklift blade slot 1700. The apparatus 200 may further include an enclosure 250 for enclosing the frame 260. And, the apparatus 200 may be mounted on a bridge 120 of a gantry robot 110.

According to another embodiment, there is provided an apparatus 200 for picking and placing a layer 151 of product 150, a pallet 181, or the layer 151 of product 150 on the pallet 181, comprising: a frame 260, the frame 260 movable from a first position 10 above and clear of the layer 151 of product 150, the pallet 181, or the layer 151 of product 150 on the pallet 181 to a second position 20 over and enclosing the layer 151 of product 150, the pallet 181, or the layer 151 of product 150 on the pallet 181; paddles 208 mounted on internal sides 410 of the frame 460, each paddle 208 moveable from a first position 30 in which the paddle 208 is clear of the layer 151 of product 150, if present, to a second position 40 in which the paddle 208 engages and grips a respective side 153 of the layer 151 of product 150, if present, by applying mechanical force thereto; a vacuum duct 202 mounted in the frame 260 over the layer 151 of product 150, if present, the vacuum duct 202 moveable from a first position 50 in which the vacuum duct 202 is clear of the layer 151 of product 150, if present, to a second position 60 in which the vacuum duct 202 engages and grips a top 154 of the layer 151 of product 150, if present, by applying vacuum force thereto; a pallet support 210 mounted on a base 270 of the frame 260, the pallet support 210 moveable from a first position 93 in which the pallet support 210 is clear of the pallet 181, if present, to a second position 94 in which the pallet support 210 is under a horizontal surface (e.g., 182, 1701) of the pallet 181, if present; and, a control system 300 adapted to selectively control respective mechanisms 420, 206, 209, 211 for positioning of the frame 260, paddles 208, vacuum duct 202, and pallet support 210 to thereby pick and place the layer 151 of product 150, the pallet 181, or the layer 151 of product 150 on the pallet 181.

The apparatus 200 may further include a belt 212 mounted on the frame 260, the belt 212 movable from a first position 90 in which the belt 212 is clear of a bottom 155 of the layer 151 of product 150, if present, when lifted to a second position 91 in which the belt 212 is extended across the bottom 155 of the layer 151 of product 150, if present, when lifted to thereby prevent items 152 of product 150 from dropping from the layer 151 of product 150, if present, when lifted, and the control system 300 may be further adapted to selectively control a mechanism 213, 214 for positioning of the belt 212. The horizontal surface of the pallet may be one of an upper surface 1701 of a forklift blade slot 1700 of the pallet 181 and a bottom 182 of the pallet 181. The layer 151 of product 150 may be at least one layer 151 of product 150. Each paddle 208 may be at least two paddles 208. Ends 442 of the at least two paddles 208 on adjacent internal sides 410 of the frame 260 may be interwoven 440. The belt 212 may be at least one belt 212. The pallet support 210 may be at least one pallet support 210 and the horizontal surface 182, 1701 may be at least one horizontal surface 182, 1701. The apparatus 200 may further include an enclosure 250 for enclosing the frame 260. And, the frame 260 may be mounted on a carriage 160 on a bridge 120 of a gantry robot 110.

According to another embodiment, there is provided a system 100 for assembling an order stack 180, comprising: an infeed 130 adapted to receive first and second source stacks 140, 141, the first source stack 140 including layers 151 of a first product 150, the second source 141 stack including layers 151 of a second product 156; a robot 110 for moving the first and second source stacks 140, 141 from the infeed 130 to respective first and second locations 172, 173 within a storage area (e.g., floor 170 and/or grid 171); an outfeed 190 adapted to receive layers 151 of product 150, 156 for the order stack 180; a control system 300 adapted to receive an order 331 (e.g., via GUI 380 or interface 350 and stored in memory 330 or otherwise) specifying a number of layers (e.g., two layers 151) of the first product 150 and a number of layers (e.g., one layer 151) of the second product 156 for the order stack 180 and to control the robot 110 to: pick the number of layers of the first product 150 from the first source stack 140 at the first location 172 within the storage area 170, 171 and place the number of layers of the first product 150 on the outfeed 190; and, pick the number of layers of the second product 156 from the second source stack 141 at the second location 173 in the storage area 170, 171 and place the number of layers of the second product 156 on the number of layers of the first product 150 on the outfeed 190 to thereby assembly the order stack 180. Note that the first and second products 150, 156 may be the same product.

In the above system 100, the infeed 130 may be a conveyor belt 131. The outfeed 190 may be a conveyor belt 191. The storage area 170, 171 may be a floor 170. The floor 170 may be located in a warehouse 175. The layers 151 of product 150, 156 for the order stack 180 may be placed on a pallet 181 on the outfeed 190. The robot 110 may be a gantry robot 110. The gantry robot 110 may include an apparatus 200 for picking and placing at least one layer 151 of product (e.g., 150), the apparatus 200 including: a frame 260, the frame 260 movable from a first position 10 above and clear of the at least one layer 151 of product 150 to a second position 20 over and enclosing the at least one layer 151 of product 150; paddles 208 mounted on internal sides 410 of the frame 260, each paddle 208 moveable from a first position 30 in which the paddle 208 is clear of the at least one layer 151 of product 150 to a second position 40 in which the paddle 208 engages and grips a respective side 153 of the at least one layer 151 of product 150 by applying mechanical force thereto; a vacuum duct 202 mounted in the frame 260 over the at least one layer 151 of product 150, the vacuum duct 202 moveable from a first position 50 in which the vacuum duct 202 is clear of the at least one layer 151 of product 150 to a second position 60 in which the vacuum duct 202 engages and grips a top 154 of the at least one layer 151 of product 150 by applying vacuum force thereto; and, wherein the control system 300 is adapted to selectively control respective mechanisms (e.g., 420, 206, 209) for positioning of the frame 260, paddles 208, and vacuum duct 202 to thereby pick and place the at least one layer 151 of product 150. The apparatus 200 may further include a belt 212 mounted on the frame 260, the belt 212 movable from a first position 90 in which the belt 212 is clear of a bottom 155 of the at least one layer 151 of product 150 when lifted to a second position 91 in which the belt 212 is extended across the bottom 155 of the at least one layer 151 of product 150 when lifted to thereby prevent items 152 of product 150 from dropping from the at least one layer 151 of product 150 when lifted, and the control system 300 may be further adapted to selectively control a mechanism (e.g., 213, 214) for positioning of the belt 212. The at least one layer 151 of product 150 may be mounted on a pallet 181 and the apparatus 200 may further include a pallet support 210 mounted on a base 270 of the frame 260, the pallet support 210 moveable from a first position 93 in which the pallet support 210 is clear of the pallet 181 to a second position 94 in which the pallet support 210 engages the pallet 181 by entering a forklift blade slot 1700 of the pallet 181, and the control system 300 may be further adapted to selectively control a mechanism 211 for positioning of the pallet support 210 to thereby lift the at least one layer 151 of product 150 and the pallet 181.

According to another embodiment, there is provided a method for assembling an order stack 180, comprising: receiving first and second source stacks 140, 141 from an infeed 130, the first source stack 140 including layers 151 of a first product 150, the second source 141 stack including layers 151 of a second product 156; moving the first and second source stacks 140, 141 from the infeed 130 to respective first and second locations 172, 173 within a storage area (e.g., floor 170 and/or grid 171) using a robot 110; receiving at a control system 300 an order 331 (e.g., via GUI 380 or interface 350 and stored in memory 330 or otherwise) specifying a number of layers (e.g., two layers 151) of the first product 150 and a number of layers (e.g., one layer 151) of the second product 156 for the order stack 180; and, controlling the robot 110 with the control system 300 to: pick the number of layers of the first product 150 from the first source stack 140 at the first location 172 within the storage area 170, 171 and place the number of layers of the first product 150 on the outfeed 190; and, pick the number of layers of the second product 156 from the second source stack 141 at the second location 173 in the storage area 170, 171 and place the number of layers of the second product 156 on the number of layers of the first product 150 on the outfeed 190 to thereby assembly the order stack 180. Note that the first and second products 150, 156 may be the same product.

In the above method, the infeed 130 may be a conveyor belt 131. The outfeed 190 may be a conveyor belt 191. The storage area 170, 171 may be a floor 170. The floor 170 may be located in a warehouse 175. The layers 151 of product 150, 156 for the order stack 180 may be placed on a pallet 181 on the outfeed 190. The robot 110 may be a gantry robot 110. The gantry robot 110 may include an apparatus 200 for picking and placing at least one layer 151 of product (e.g., 150), the apparatus 200 including: a frame 260, the frame 260 movable from a first position 10 above and clear of the at least one layer 151 of product 150 to a second position 20 over and enclosing the at least one layer 151 of product 150; paddles 208 mounted on internal sides 410 of the frame 260, each paddle 208 moveable from a first position 30 in which the paddle 208 is clear of the at least one layer 151 of product 150 to a second position 40 in which the paddle 208 engages and grips a respective side 153 of the at least one layer 151 of product 150 by applying mechanical force thereto; a vacuum duct 202 mounted in the frame 260 over the at least one layer 151 of product 150, the vacuum duct 202 moveable from a first position 50 in which the vacuum duct 202 is clear of the at least one layer 151 of product 150 to a second position 60 in which the vacuum duct 202 engages and grips a top 154 of the at least one layer 151 of product 150 by applying vacuum force thereto; and, wherein the control system 300 is adapted to selectively control respective mechanisms (e.g., 420, 206, 209) for positioning of the frame 260, paddles 208, and vacuum duct 202 to thereby lift and place the at least one layer 151 of product 150. The apparatus 200 may further include a belt 212 mounted on the frame 260, the belt 212 movable from a first position 90 in which the belt 212 is clear of a bottom 155 of the at least one layer 151 of product 150 when lifted to a second position 91 in which the belt 212 is extended across the bottom 155 of the at least one layer 151 of product 150 when lifted to thereby prevent items 152 of product 150 from dropping from the at least one layer 151 of product 150 when lifted, and the control system 300 may be further adapted to selectively control a mechanism (e.g., 213, 214) for positioning of the belt 212. The at least one layer 151 of product 150 may be mounted on a pallet 181 and the apparatus 200 may further include a pallet support 210 mounted on a base 270 of the frame 260, the pallet support 210 moveable from a first position 93 in which the pallet support 210 is clear of the pallet 181 to a second position 94 in which the pallet support 210 engages the pallet 181 by entering a forklift blade slot 1700 of the pallet 181, and the control system 300 may be further adapted to selectively control a mechanism 211 for positioning of the pallet support 210 to thereby lift the at least one layer 151 of product 150 and the pallet 181.

According to one embodiment, some of above steps may be implemented by respective software module 331. According to another embodiment, some of the above steps may be implemented by respective hardware module 321. According to another embodiment, some of the above steps may be implemented by a combination of software 331 and hardware modules 321.

While some aspects of this invention may be described as a method, a person of ordinary skill in the art will understand that the apparatus discussed above with reference to a data processing system 300 may be programmed to enable the practice of the method of the invention. Moreover, an article of manufacture for use with a data processing system 300, such as a pre-recorded storage device or other similar computer readable medium including program instructions recorded thereon, may direct the data processing system 300 to facilitate the practice of the method of the invention. It is understood that such apparatus and articles of manufacture also come within the scope of the invention. In particular, the sequences of instructions which when executed cause the method described herein to be performed by the data processing system 300 can be contained in a data carrier product according to one embodiment of the invention. This data carrier product can be loaded into and run by the data processing system 300. In addition, the sequences of instructions which when executed cause the method described herein to be performed by the data processing system 300 can be contained in a computer software product according to one embodiment of the invention. This computer software product can be loaded into and run by the data processing system 300. Moreover, the sequences of instructions which when executed cause the method described herein to be performed by the data processing system 300 can be contained in an integrated circuit product (e.g., a hardware module or modules 321) which may include a coprocessor or memory according to one embodiment of the invention. This integrated circuit product can be installed in the data processing system 300.

The embodiments of the invention described above are intended to be exemplary only. Those skilled in the art will understand that various modifications of detail may be made to these embodiments, all of which come within the scope of the invention.

What is claimed is:

1. An apparatus for picking and placing a layer of product, comprising:
a frame, the frame movable from a first position above and clear of the layer of product to a second position over and enclosing the layer of product;
paddles mounted on internal sides of the frame, each paddle moveable from a first position in which the paddle is clear of the layer of product to a second position in which the paddle engages and grips a respective side of the layer of product by applying mechanical force thereto;
a vacuum duct mounted in the frame over the layer of product, the vacuum duct moveable from a first position in which the vacuum duct is clear of the layer of product to a second position in which the vacuum duct engages and grips a top of the layer of product by applying vacuum force thereto; and,
a control system adapted to selectively control respective mechanisms for positioning of the frame, paddles, and vacuum duct to thereby pick and place the layer of product.

2. The apparatus of claim 1 and further comprising a belt mounted on the frame, the belt movable from a first position in which the belt is clear of a bottom of the layer of product when lifted to a second position in which the belt is extended across the bottom of the layer of product when lifted to thereby prevent items of product from dropping from the layer of product when lifted, and wherein the control system is further adapted to selectively control a mechanism for positioning of the belt.

3. The apparatus of claim 1, wherein the layer of product is mounted on a pallet, and further comprising a pallet support mounted on a base of the frame, the pallet support moveable from a first position in which the pallet support is clear of the pallet to a second position in which the pallet support engages the pallet by entering a forklift blade slot of the pallet, and wherein the control system is further adapted to selectively control a mechanism for positioning of the pallet support to thereby lift the layer of product and the pallet.

4. The apparatus of claim 1 wherein the layer of product is at least one layer of product.

5. The apparatus of claim 1 wherein each paddle is at least two paddles.

6. The apparatus of claim 5 wherein ends of the at least two paddles on adjacent internal sides of the frame are interwoven.

7. The apparatus of claim 2 wherein the belt is at least one belt.

8. The apparatus of claim 3 wherein the pallet support is at least one pallet support and wherein the forklift blade slot is at least one forklift blade slot.

9. The apparatus of claim 1 and further comprising an enclosure for enclosing the frame.

10. The apparatus of claim 1 wherein the frame is mounted on a bridge of a gantry robot.

11. A system for assembling an order stack, comprising:
an infeed adapted to receive first and second source stacks, the first source stack including layers of a first product, the second source stack including layers of a second product;
a robot for moving the first and second source stacks from the infeed to respective first and second locations within a storage area;
an outfeed adapted to receive layers of product for the order stack;
a control system adapted to receive an order specifying a number of layers of the first product and a number of layers of the second product for the order stack and to control the robot to: pick the number of layers of the first product from the first source stack at the first location in the storage area and place the number of layers of the first product on the outfeed;
and, pick the number of layers of the second product from the second source stack at the second location in the storage area and place the number of layers of the second product on the number of layers of the first product on the outfeed to thereby assembly the order stack.

12. The system of claim 11 wherein the infeed is a conveyor belt.

13. The system of claim 11 wherein the outfeed is a conveyor belt.

14. The system of claim 11 wherein the storage area is a floor.

15. The system of claim 14 wherein the floor is located in a warehouse.

16. The system of claim 11 wherein the layers of product for the order stack are placed on a pallet on the outfeed.

17. The system of claim 11 wherein the robot is a gantry robot.

18. The system of claim 17 wherein the gantry robot includes an apparatus for picking and placing at least one layer of product, the apparatus including:
a frame, the frame movable from a first position above and clear of the at least one layer of product to a second position over and enclosing the at least one layer of product;
paddles mounted on internal sides of the frame, each paddle moveable from a first position in which the paddle is clear of the at least one layer of product to a second position in which the paddle engages and grips a respective side of the at least one layer of product by applying mechanical force thereto;
a vacuum duct mounted in the frame over the at least one layer of product, the vacuum duct moveable from a first position in which the vacuum duct is clear of the at least one layer of product to a second position in which the vacuum duct engages and grips a top of the at least one layer of product by applying vacuum force thereto; and,
wherein the control system is adapted to selectively control respective mechanisms for positioning of the frame, paddles, and vacuum duct to thereby lift and place the at least one layer of product.

19. The system of claim 18 wherein the apparatus further includes a belt mounted on the frame, the belt movable from a first position in which the belt is clear of a bottom of the at least one layer of product when lifted to a second position in which the belt is extended across the bottom of the at least one layer of product when lifted to thereby prevent items of product from dropping from the at least one layer of product when lifted, and wherein the control system is further adapted to selectively control a mechanism for positioning of the belt.

20. The system of claim 18, wherein the at least one layer of product is mounted on a pallet, and wherein the apparatus further includes a pallet support mounted on a base of the frame, the pallet support moveable from a first position in which the pallet support is clear of the pallet to a second position in which the pallet support engages the pallet by entering a forklift blade slot of the pallet, and wherein the control system is further adapted to selectively control a mechanism for positioning of the pallet support to thereby lift the at least one layer of product and the pallet.

21. A method for assembling an order stack, comprising:
receiving first and second source stacks from an infeed, the first source stack including layers of a first product, the second source stack including layers of a second product;
moving the first and second source stacks from the infeed to respective first and second locations within a storage area using a robot;
receiving at a control system an order specifying a number of layers of the first product and a number of layers of the second product for the order stack; and,
controlling the robot with the control system to: pick the number of layers of the first product from the first source stack at the first location in the storage area and place the number of layers of the first product on an outfeed; and, pick the number of layers of the second product from the second source stack at the second location in the storage area and place the number of layers of the second product on the number of layers of the first product on the outfeed to thereby assembly the order stack.

22. The method of claim 21 wherein the infeed is a conveyor belt.

23. The method of claim 21 wherein the outfeed is a conveyor belt.

24. The method of claim 21 wherein the storage area is a floor.

25. The method of claim 24 wherein the floor is located in a warehouse.

26. The method of claim 21 wherein the layers of product for the order stack are placed on a pallet on the outfeed.

27. The method of claim 21 wherein the robot is a gantry robot.

28. The method of claim 27 wherein the gantry robot includes an apparatus for picking and placing at least one layer of product, the apparatus including:
a frame, the frame movable from a first position above and clear of the at least one layer of product to a second position over and enclosing the at least one layer of product;
paddles mounted on internal sides of the frame, each paddle moveable from a first position in which the paddle is clear of the at least one layer of product to a second position in which the paddle engages and grips a respective side of the at least one layer of product by applying mechanical force thereto;
a vacuum duct mounted in the frame over the at least one layer of product, the vacuum duct moveable from a first position in which the vacuum duct is clear of the at least one layer of product to a second position in which the vacuum duct engages and grips a top of the at least one layer of product by applying vacuum force thereto; and,
wherein the control system is adapted to selectively control respective mechanisms for positioning of the frame, paddles, and vacuum duct to thereby lift and place the at least one layer of product.

29. The method of claim 28 wherein the apparatus further includes a belt mounted on the frame, the belt movable from a first position in which the belt is clear of a bottom of the at least one layer of product when lifted to a second position in which the belt is extended across the bottom of the at least one layer of product when lifted to thereby prevent items of product from dropping from the at least one layer of product when lifted, and wherein the control system is further adapted to selectively control a mechanism for positioning of the belt.

30. The method of claim 18, wherein the at least one layer of product is mounted on a pallet, and wherein the apparatus further includes a pallet support mounted on a base of the frame, the pallet support moveable from a first position in which the pallet support is clear of the pallet to a second position in which the pallet support engages the pallet by entering a forklift blade slot of the pallet, and wherein the control system is further adapted to selectively control a mechanism for positioning of the pallet support to thereby lift the at least one layer of product and the pallet.

31. An apparatus for picking and placing a layer of product, a pallet, or the layer of product on the pallet, comprising:
a frame, the frame movable from a first position above and clear of the layer of product, the pallet, or the layer of product on the pallet to a second position over and enclosing the layer of product, the pallet, or the layer of product on the pallet;
paddles mounted on internal sides of the frame, each paddle moveable from a first position in which the paddle is clear of the layer of product, if present, to a second position in which the paddle engages and grips a respective side of the layer of product, if present, by applying mechanical force thereto;
a vacuum duct mounted in the frame over the layer of product, if present, the vacuum duct moveable from a first position in which the vacuum duct is clear of the layer of product, if present, to a second position in which the vacuum duct engages and grips a top of the layer of product, if present, by applying vacuum force thereto;
a pallet support mounted on a base of the frame, the pallet support moveable from a first position in which the pallet support is clear of the pallet, if present, to a second position in which the pallet support is under a horizontal surface of the pallet, if present; and,
a control system adapted to selectively control respective mechanisms for positioning of the frame, paddles, vacuum duct, and pallet support to thereby pick and place the layer of product, the pallet, or the layer of product on the pallet.

32. The apparatus of claim 31 and further comprising a belt mounted on the frame, the belt movable from a first position in which the belt is clear of a bottom of the layer of product, if present, when lifted to a second position in which the belt is extended across the bottom of the layer of product, if present, when lifted to thereby prevent items of product from dropping from the layer of product, if present, when lifted, and wherein the control system is further adapted to selectively control a mechanism for positioning of the belt.

33. The apparatus of claim 31 wherein the horizontal surface of the pallet is one of an upper surface of a forklift blade slot of the pallet and a bottom of the pallet.

34. The apparatus of claim 31 wherein the layer of product is at least one layer of product.

35. The apparatus of claim 31 wherein each paddle is at least two paddles.

36. The apparatus of claim 35 wherein ends of the at least two paddles on adjacent internal sides of the frame are interwoven.

37. The apparatus of claim 32 wherein the belt is at least one belt.

38. The apparatus of claim 31 wherein the pallet support is at least one pallet support and wherein the horizontal surface is at least one horizontal surface.

39. The apparatus of claim 31 and further comprising an enclosure for enclosing the frame.

40. The apparatus of claim 31 wherein the frame is mounted on a carriage on a bridge of a gantry robot.
